(19) United States
(12) Patent Application Publication
(10) Pub. No.: US 2023/0273415 A1
(43) Pub. Date: Aug. 31, 2023

(54) ZOOM OPTICAL SYSTEM, OPTICAL APPARATUS AND METHOD FOR MANUFACTURING THE ZOOM OPTICAL SYSTEM

(71) Applicant: Nikon Corporation, Minato-ku, Tokyo (JP)

(72) Inventor: Kosuke MACHIDA, Tokyo (JP)

(21) Appl. No.: 18/018,036

(22) PCT Filed: Jun. 25, 2021
(86) PCT No.: PCT/JP2021/024061

§ 371 Date: Jan. 25, 2023

(30) Foreign Application Priority Data
Jul. 28, 2020 (JP) 2020-126910

(51) Int. Cl. G02B 15/14; G02B 15/16

(52) U.S. Cl. CPC G02B 15/1461; G02B 15/16

(57) ABSTRACT

A variable-magnification optical system (ZL) has a front-side lens group (GA) having a positive refractive power, a first intermediate lens group (GM1) having a negative refractive power, a second intermediate lens group (GM2) having a positive refractive power, and a succeeding lens group (GR), the succeeding lens group (GR) including a plurality of focusing lens groups that move along the optical axis during focusing, and satisfying the following conditions: −0.37<fFs/fFy<0.37, and 2.00<f1/fw/8.00, where fFs is the focal length of the focusing lens group that has the greatest refractive power from among the focusing lens groups, fFy is the focal length of the focusing lens group that has the smallest refractive power from among the focusing lens groups, f1 is the focal length of the front-side lens group (GA), and fw is the focal length of the variable-magnification optical system (ZL) at the wide-angle end thereof.

### TECHNICAL FIELD

The present invention relates to a zoom optical system, an optical apparatus, and a method for manufacturing the zoom optical system.

### TECHNICAL BACKGROUND

Conventionally, a zoom optical system suitable for a picture camera, an electronic still camera, a video camera, and the like has been disclosed (for example, refer to Patent literature 1). In such a zoom optical system, it has been difficult to prevent aberration fluctuation upon focusing.

### PRIOR ARTS LIST

### Patent Document

Patent literature 1: Japanese Laid-open Patent Publication No. 2019-12243(A)

### SUMMARY OF THE INVENTION

A zoom optical system according to the present invention comprises a front-side lens group having positive refractive power, a first middle lens group having negative refractive power, a second middle lens group having positive refractive power, and a succeeding lens group, the lens groups being arranged in order from an object side along an optical axis, intervals of the lens groups adjacent to each other change at zooming, the succeeding lens group includes a first focusing lens group disposed closest to the object side in the succeeding lens group and configured to move along the optical axis upon focusing, and at least one other focusing lens group disposed on an image side of the first focusing lens group and configured to move along the optical axis with a locus different from a locus of the first focusing lens group upon focusing, and the following conditional expressions are satisfied.

−0.37<fFs/fFy<0.37

2.00<f1/fw<8.00

where

fFs: focal length of a focusing lens group having strongest refractive power among the focusing lens groups included in the succeeding lens group,

fFy: focal length of a focusing lens group having weakest refractive power among the focusing lens groups included in the succeeding lens group,

f1: focal length of the front-side lens group, and

fw: focal length of the zoom optical system in a wide-angle end state.

An optical apparatus according to the present invention comprises the above-described zoom optical system.

The method for manufacturing a zoom optical system according to the present invention, in which the zoom optical system comprises a front-side lens group having positive refractive power, a first middle lens group having negative refractive power, a second middle lens group having positive refractive power, and a succeeding lens group, the lens groups being arranged in order from an object side along an optical axis, comprises a step of disposing the front-side lens group, the first middle lens group, the second middle lens group and the succeeding lens group in a lens barrel so that;

intervals of the lens groups adjacent to each other change at zooming,

the succeeding lens group includes a first focusing lens group disposed closest to the object side in the succeeding lens group and configured to move along the optical axis upon focusing, and at least one other focusing lens group disposed on an image side of the first focusing lens group and configured to move along the optical axis with a locus different from a locus of the first focusing lens group upon focusing, and

the following conditional expressions are satisfied.

−0.37<fFs/fFy<0.37

2.00<f1/fw<8.00

where

fFs: focal length of a focusing lens group having strongest refractive power among the focusing lens groups included in the succeeding lens group,

fFy: focal length of a focusing lens group having weakest refractive power among the focusing lens groups included in the succeeding lens group,

f1: focal length of the front-side lens group, and

fw: focal length of the zoom optical system in a wide-angle end state.

### BRIEF DESCRIPTION OF THE DRAWINGS

FIG. 1 is a diagram illustrating a lens configuration of a zoom optical system according to a first example;

FIGS. 2A and 2B illustrate various aberration diagrams of the zoom optical system according to the first example upon focusing on infinity in a wide-angle end state and a telephoto end state, respectively;

FIGS. 3A and 3B illustrate various aberration diagrams of the zoom optical system according to the first example upon focusing on a short-distance object in the wide-angle end state and the telephoto end state, respectively;

FIG. 4 is a diagram illustrating a lens configuration of a zoom optical system according to a second example;

FIGS. 5A and 5B illustrate various aberration diagrams of the zoom optical system according to the second example upon focusing on infinity in the wide-angle end state and the telephoto end state, respectively;

FIGS. 6A and 6B illustrate various aberration diagrams of the zoom optical system according to the second example upon focusing on a short-distance object in the wide-angle end state and the telephoto end state, respectively;

FIG. 7 is a diagram illustrating a lens configuration of a zoom optical system according to a third example;

FIGS. 8A and 8B illustrate various aberration diagrams of the zoom optical system according to the third example upon focusing on infinity in the wide-angle end state and the telephoto end state, respectively;

FIGS. 9A and 9B illustrate various aberration diagrams of the zoom optical system according to the third example upon focusing on a short-distance object in the wide-angle end state and the telephoto end state, respectively;

FIG. 10 is a diagram illustrating a lens configuration of a zoom optical system according to a fourth example;

FIGS. 11A and 11B illustrate various aberration diagrams of the zoom optical system according to the fourth example upon focusing on infinity in the wide-angle end state and the telephoto end state, respectively;

FIGS. 12A and 12B illustrate various aberration diagrams of the zoom optical system according to the fourth example upon focusing on a short-distance object in the wide-angle end state and the telephoto end state, respectively;

FIG. 13 is a diagram illustrating a lens configuration of a zoom optical system according to a fifth example;

FIGS. 14A and 14B illustrate various aberration diagrams of the zoom optical system according to the fifth example upon focusing on infinity in the wide-angle end state and the telephoto end state, respectively;

FIGS. 15A and 15B illustrate various aberration diagrams of the zoom optical system according to the fifth example upon focusing on a short-distance object in the wide-angle end state and the telephoto end state, respectively;

FIG. 16 is a diagram illustrating a lens configuration of a zoom optical system according to a sixth example;

FIGS. 17A and 17B illustrate various aberration diagrams of the zoom optical system according to the sixth example upon focusing on infinity in the wide-angle end state and the telephoto end state, respectively;

FIGS. 18A and 18B illustrate various aberration diagrams of the zoom optical system according to the sixth example upon focusing on a short-distance object in the wide-angle end state and the telephoto end state, respectively;

FIG. 19 is a diagram illustrating a lens configuration of a zoom optical system according to a seventh example;

FIGS. 20A and 20B illustrate various aberration diagrams of the zoom optical system according to the seventh example upon focusing on infinity in the wide-angle end state and the telephoto end state, respectively;

FIGS. 21A and 21B illustrate various aberration diagrams of the zoom optical system according to the seventh example upon focusing on a short-distance object in the wide-angle end state and the telephoto end state, respectively;

FIG. 22 is a diagram illustrating the configuration of a camera comprising a zoom optical system according to the present embodiment; and

FIG. 23 is a flowchart illustrating a method for manufacturing the zoom optical system according to the present embodiment.

### DESCRIPTION OF THE EMBODIMENTS

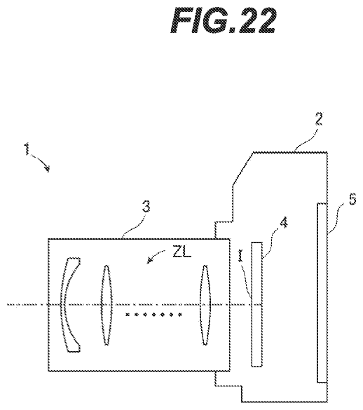

Preferable embodiments according to the present invention will be described below. First, a camera (optical apparatus) comprising a zoom optical system according to the present embodiment will be described with reference to FIG. 22. As illustrated in FIG. 22, this camera 1 is constituted by a body 2 and a photographing lens 3 mounted on the body 2. The body 2 comprises an image capturing element 4, a body control part (not illustrated) configured to control operation of the digital camera, and a liquid crystal screen 5. The photographing lens 3 comprises a zoom optical system ZL consisting of a plurality of lens groups, and a lens position control mechanism (not illustrated) configured to control the position of each lens group. The lens position control mechanism is constituted by a sensor configured to detect the position of each lens group, a motor configured to move each lens group forward and backward along an optical axis, a control circuit configured to drive the motor, and the like.

Light from an object is collected by the zoom optical system ZL of the photographing lens 3 and reaches an image surface I of the image capturing element 4. The light having reached the image surface I from the object is photoelectrically converted by the image capturing element 4 and recorded as digital image data in a non-illustrated memory. The digital image data recorded in the memory can be displayed on the liquid crystal screen 5 in accordance with an operation by a user. Note that the camera may be a mirrorless camera or a single-lens reflex camera comprising a quick-return mirror. The zoom optical system ZL illustrated in FIG. 22 schematically illustrates a zoom optical system comprised in the photographing lens 3, and a lens configuration of the zoom optical system ZL is not limited to this configuration.

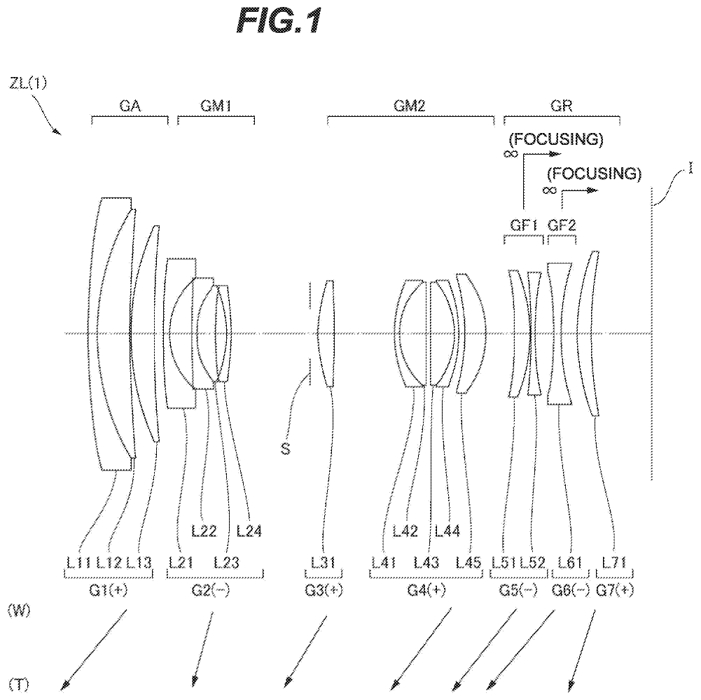

The zoom optical system according to the present embodiment will be described next. As illustrated in FIG. 1, the zoom optical system ZL(1) as an example of the zoom optical system (zoom lens) ZL according to the present embodiment comprises a front-side lens group GA having positive refractive power, a first middle lens group GM1 having negative refractive power, a second middle lens group GM2 having positive refractive power, and a succeeding lens group GR, the lens groups being arranged in order from an object side along the optical axis. The intervals of the lens groups adjacent to each other change upon zooming. The succeeding lens group GR includes a first focusing lens group GF1 disposed closest to the object side in the succeeding lens group GR and configured to move along the optical axis upon focusing, and at least one other focusing lens group disposed on an image side of the first focusing lens group GF1 and configured to move along the optical axis with a locus different from that of the first focusing lens group GF1 upon focusing.

With the above-described configuration, the zoom optical system ZL according to the present embodiment satisfies the following conditional expressions (1) and (2).

−0.37<fFs/fFy<0.37 (1)

2.00<f1/fw<8.00 (2)

where

fFs: focal length of a focusing lens group having the strongest refractive power among focusing lens groups included in the succeeding lens group GR,

fFy: focal length of a focusing lens group having the weakest refractive power among the focusing lens groups included in the succeeding lens group GR,

f1: focal length of the front-side lens group GA, and

fw: focal length of the zoom optical system ZL in a wide-angle end state.

According to the present embodiment, it is possible to obtain a zoom optical system with small aberration fluctuation upon focusing and an optical apparatus comprising the zoom optical system. Note that, since the succeeding lens group GR comprises a plurality of focusing lens groups, it is possible to prevent variation in various aberrations such as spherical aberration upon focusing without increase in the sizes of the focusing lens groups. Moreover, since the interval between the lens groups adjacent to each other changes upon zooming, it is possible to excellently perform aberration correction upon zooming.

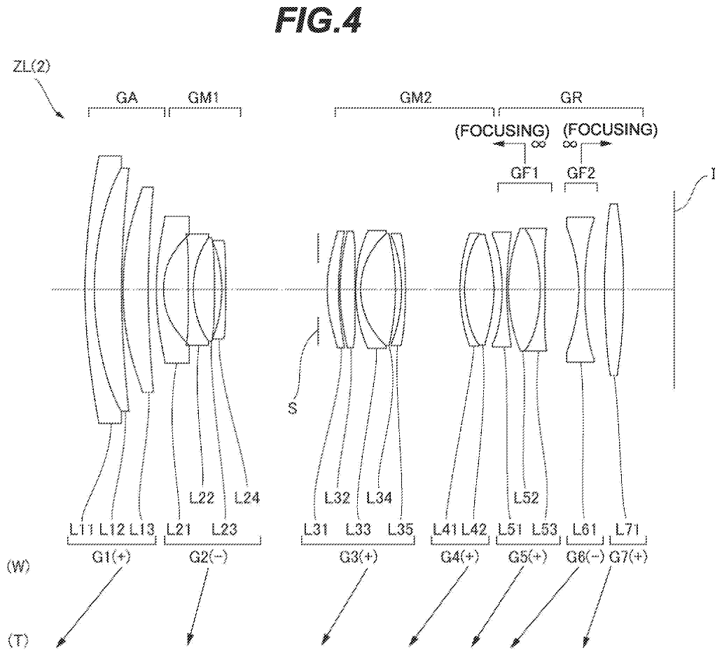

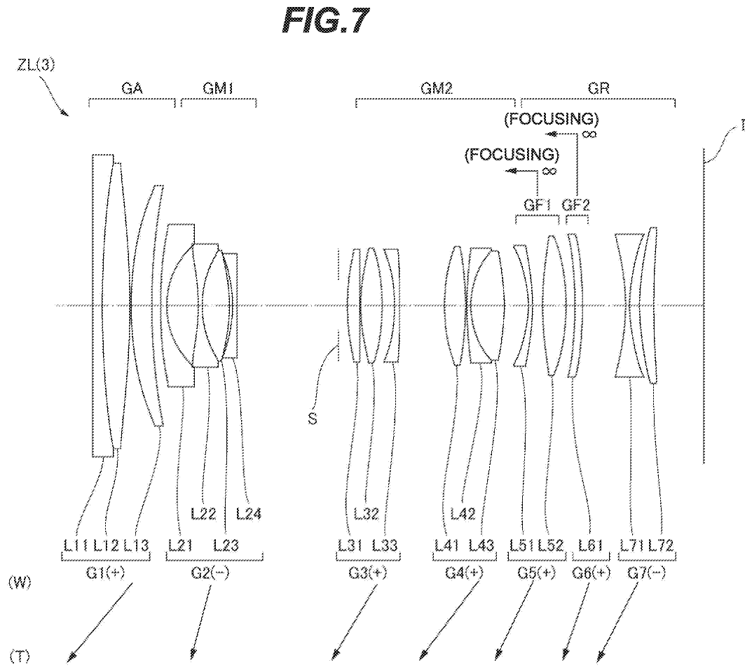

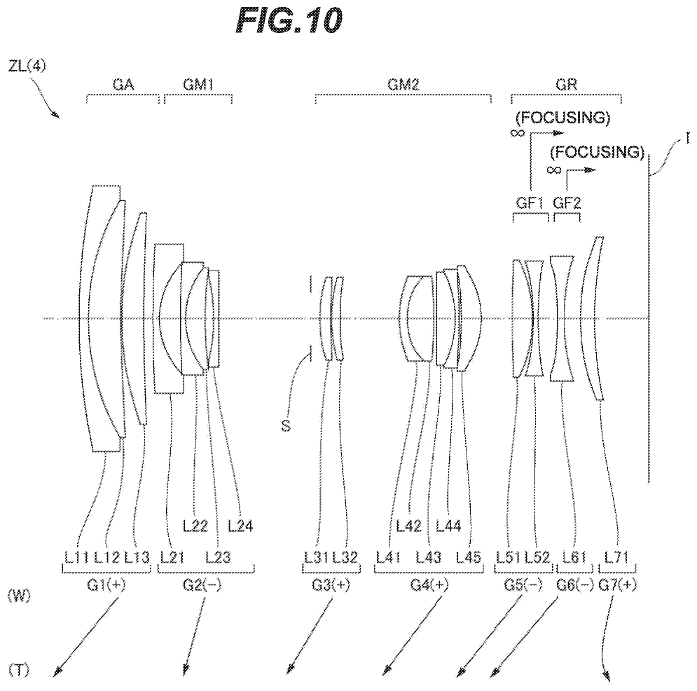

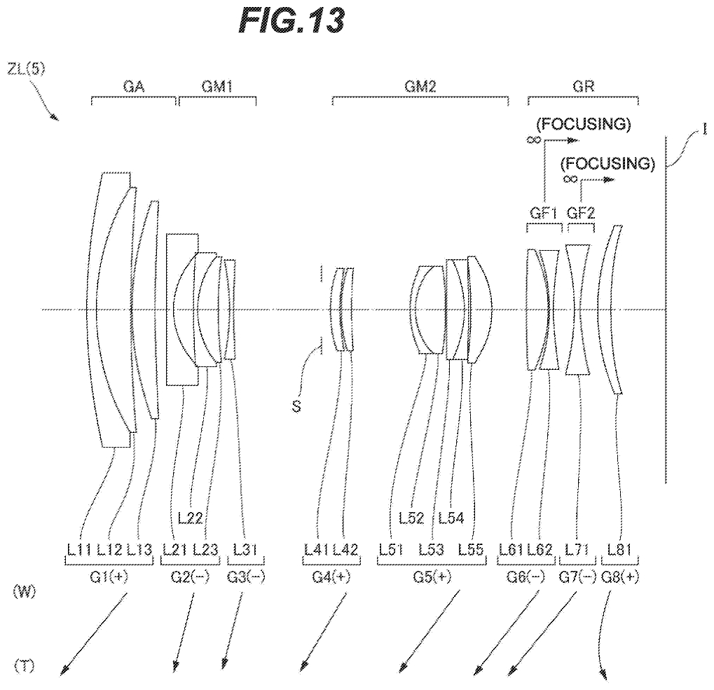

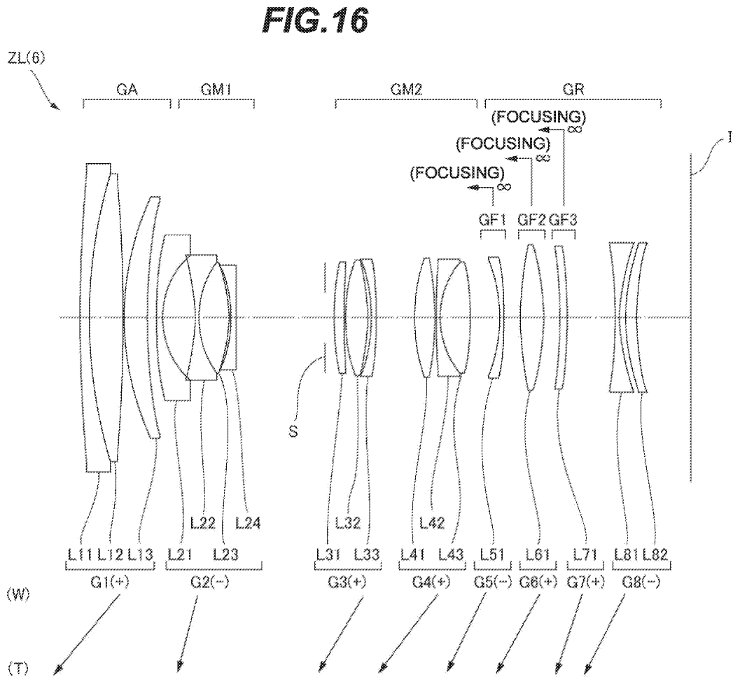

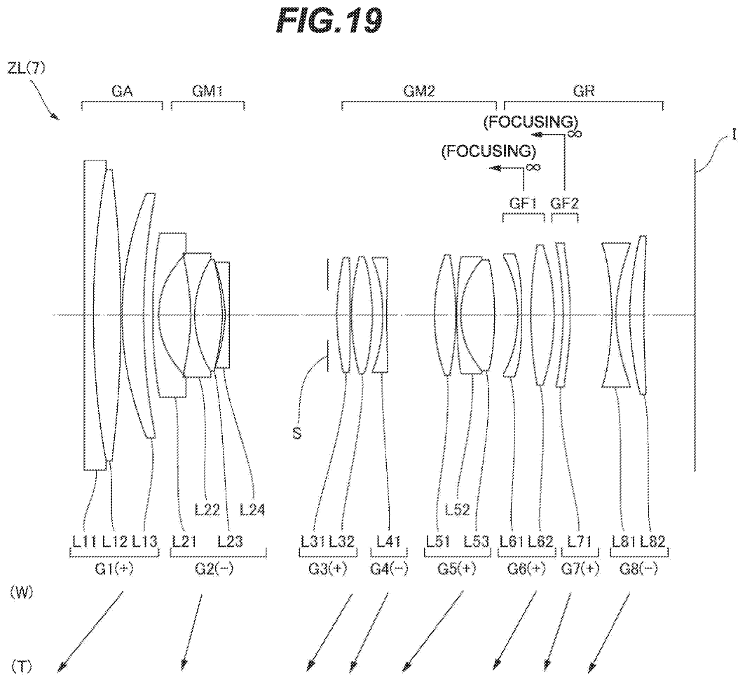

The zoom optical system ZL according to the present embodiment may be a zoom optical system ZL(2) illustrated in FIG. 4, may be a zoom optical system ZL(3) illustrated in FIG. 7, or may be a zoom optical system ZL(4) illustrated in FIG. 10. Alternatively, the zoom optical system ZL according to the present embodiment may be a zoom optical system ZL(5) illustrated in FIG. 13, may be a zoom optical system ZL(6) illustrated in FIG. 16, or may be a zoom optical system ZL(7) illustrated in FIG. 19.

The conditional expression (1) defines an appropriate relation between the focal length of the focusing lens group having the strongest refractive power among the focusing lens groups included in the succeeding lens group GR and the focal length of the focusing lens group having the weakest refractive power among the focusing lens groups included in the succeeding lens group GR. It is possible to prevent variation in various aberrations such as spherical aberration upon focusing by satisfying the conditional expression (1).

When the correspondence value of the conditional expression (1) is equal to or larger than the upper limit value, the refractive power difference between the focusing lens group having the strongest refractive power and the focusing lens group having the weakest refractive power is small, and thus it is difficult to prevent variation in various aberrations such as spherical aberration upon focusing. It is possible to more reliably obtain the effects of the present embodiment by setting the upper limit value of the conditional expression (1) to 0.35, 0.30, 0.28, 0.26, 0.20, 0.18, or 0.15.

When the correspondence value of the conditional expression (1) is equal to or smaller than the lower limit value, the refractive power difference between the focusing lens group having the strongest refractive power and the focusing lens group having the weakest refractive power is small, and thus it is difficult to prevent variation in various aberrations such as spherical aberration upon focusing. It is possible to more reliably obtain the effects of the present embodiment by setting the lower limit value of the conditional expression (1) to −0.35, −0.30, −0.25, −0.20, −1.50, −1.00, −0.50, −0.30, or −0.10.

The conditional expression (2) defines an appropriate relation between the focal length of the front-side lens group GA and the focal length of the zoom optical system ZL in the wide-angle end state. It is possible to prevent variation in various aberrations such as spherical aberration upon zooming without barrel size increase by satisfying the conditional expression (2).

When the correspondence value of the conditional expression (2) is equal to or larger than the upper limit value, the refractive power of the front-side lens group GA is weak, and accordingly, the moving amount of the front-side lens group GA upon zooming is large, which leads to a large barrel size. It is possible to more reliably obtain the effects of the present embodiment by setting the upper limit value of the conditional expression (2) to 7.80, 7.50, 7.40, 7.00, 6.50, 6.30, or 6.00.

When the correspondence value of the conditional expression (2) is equal to or smaller than the lower limit value, the refractive power of the front-side lens group GA is strong, and thus it is difficult to prevent variation in various aberrations such as spherical aberration upon zooming. It is possible to more reliably obtain the effects of the present embodiment by setting the lower limit value of the conditional expression (2) to 2.30, 2.50, 2.80, 3.00, 3.30, 3.50, or 3.80.

The zoom optical system ZL according to the present embodiment preferably satisfies the following conditional expression (3).

−6.00<fFs/fw<6.00 (3)

The conditional expression (3) defines an appropriate relation between the focal length of the focusing lens group having the strongest refractive power among the focusing lens groups included in the succeeding lens group GR and the focal length of the zoom optical system ZL in the wide-angle end state. It is possible to prevent variation in various aberrations such as spherical aberration upon focusing by satisfying the conditional expression (3).

When the correspondence value of the conditional expression (3) is equal to or larger than the upper limit value, the refractive power difference between the focusing lens group having the strongest refractive power and the focusing lens group having the weakest refractive power is small, and thus it is difficult to prevent variation in various aberrations such as spherical aberration upon focusing. It is possible to more reliably obtain the effects of the present embodiment by setting the upper limit value of the conditional expression (3) to 5.50, 5.00, 4.80, 4.50, 4.00, or 3.80.

When the correspondence value of the conditional expression (3) is equal to or smaller than the lower limit value, the refractive power of the focusing lens group having the strongest refractive power is strong, and thus it is difficult to prevent variation in various aberrations such as spherical aberration upon focusing. It is possible to more reliably obtain the effects of the present embodiment by setting the lower limit value of the conditional expression (3) to −5.50, −5.00, −4.50, −4.00, −3.50, −3.00, −2.50, −2.00, or −1.80.

The zoom optical system ZL according to the present embodiment preferably satisfies the following conditional expression (4).

4.30<f1/(−fM1w)<10.00 (4)

where

fM1w: focal length of the first middle lens group GM1 in the wide-angle end state.

The conditional expression (4) defines an appropriate relation between the focal length of the front-side lens group GA and the focal length of the first middle lens group GM1 in the wide-angle end state. It is possible to prevent variation in various aberrations such as spherical aberration upon zooming by satisfying the conditional expression (4).

When the correspondence value of the conditional expression (4) is equal to or larger than the upper limit value, the refractive power of the first middle lens group GM1 is strong, and thus it is difficult to prevent variation in various aberrations such as spherical aberration upon zooming. It is possible to more reliably obtain the effects of the present embodiment by setting the upper limit value of the conditional expression (4) to 9.50, 9.00, 8.80, 8.50, 8.30, 8.00, or 7.80.

When the correspondence value of the conditional expression (4) is equal to or smaller than the lower limit value, the refractive power of the front-side lens group GA is strong, and thus it is difficult to prevent variation in various aberrations such as spherical aberration upon zooming. It is possible to more reliably obtain the effects of the present embodiment by setting the lower limit value of the conditional expression (4) to 4.50, 4.80, 5.00, or 5.40.

In the zoom optical system ZL according to the present embodiment, the second middle lens group GM2 preferably includes at least two lens groups having positive refractive power and preferably satisfies the following conditional expression (5).

1.50<f1/fM21<7.00 (5)

where

fM21: focal length of a lens group closest to the object side among lens groups included in the second middle lens group GM2.

The conditional expression (5) defines an appropriate relation between the focal length of the front-side lens group GA and the focal length of the lens group closest to the object side among the lens groups included in the second middle lens group GM2. It is possible to prevent variation in various aberrations such as spherical aberration upon focusing by satisfying the conditional expression (5).

When the correspondence value of the conditional expression (5) is equal to or larger than the upper limit value, the refractive power of the lens group closest to the object side among the lens groups included in the second middle lens group GM2 is strong, and thus it is difficult to prevent variation in various aberrations such as spherical aberration upon focusing. It is possible to more reliably obtain the effects of the present embodiment by setting the upper limit value of the conditional expression (5) to 6.80, 6.50, 6.30, 6.00, 5.80, 5.00, 4.50, 4.00, or 3.50.

When the correspondence value of the conditional expression (5) is equal to or smaller than the lower limit value, the refractive power of the front-side lens group GA is strong, and thus it is difficult to prevent variation in various aberrations such as spherical aberration upon focusing. It is possible to more reliably obtain the effects of the present embodiment by setting the lower limit value of the conditional expression (5) to 1.60, 1.80, 2.00, 2.10, or 2.20.

The zoom optical system ZL according to the present embodiment preferably satisfies the following conditional expression (6).

0.10<BFw/fw<1.00 (6)

where

BFw: back focus of the zoom optical system ZL in the wide-angle end state.

The conditional expression (6) defines an appropriate relation between the back focus of the zoom optical system ZL in the wide-angle end state and the focal length of the zoom optical system ZL in the wide-angle end state. It is possible to excellently correct various aberrations such as coma aberration in the wide-angle end state by satisfying the conditional expression (6).

When the correspondence value of the conditional expression (6) is equal to or larger than the upper limit value, the back focus of the zoom optical system ZL in the wide-angle end state is large for the focal length of the zoom optical system ZL in the wide-angle end state, and thus it is difficult to correct various aberrations such as coma aberration in the wide-angle end state. It is possible to more reliably obtain the effects of the present embodiment by setting the upper limit value of the conditional expression (6) to 0.95, 0.90, 0.85, 0.80, 0.75, 0.70, 0.65, or 0.60.

When the correspondence value of the conditional expression (6) is equal to or smaller than the lower limit value, the back focus of the zoom optical system ZL in the wide-angle end state is small for the focal length of the zoom optical system ZL in the wide-angle end state, and thus it is difficult to correct various aberrations such as coma aberration in the wide-angle end state. Furthermore, it is difficult to dispose barrel mechanical members. It is possible to more reliably obtain the effects of the present embodiment by setting the lower limit value of the conditional expression (6) to 0.15, 0.20, 0.25, 0.30, 0.35, 0.40, or 0.43.

The zoom optical system ZL according to the present embodiment preferably satisfies the following conditional expression (7).

0.20<|fFs|/f1<2.00 (7)

The conditional expression (7) defines an appropriate relation between the focal length of the focusing lens group having the strongest refractive power among the focusing lens groups included in the succeeding lens group GR and the focal length of the front-side lens group GA. It is possible to prevent variation in various aberrations such as spherical aberration upon focusing without barrel size increase by satisfying the conditional expression (7). Moreover, it is possible to prevent variation in various aberrations such as spherical aberration upon zooming without barrel size increase.

When the correspondence value of the conditional expression (7) is equal to or larger than the upper limit value, the refractive power of the focusing lens groups is weak, and thus the moving amounts of the focusing lens groups upon focusing are large, which leads to a large barrel size. Furthermore, the refractive power of the front-side lens group GA is strong, and thus it is difficult to prevent variation in various aberrations such as spherical aberration upon zooming. It is possible to more reliably obtain the effects of the present embodiment by setting the upper limit value of the conditional expression (7) to 1.80, 1.50, 1.30, 1.00, 0.85, 0.70, 0.65, 0.60, or 0.58.

When the correspondence value of the conditional expression (7) is equal to or smaller than the lower limit value, the refractive power of the focusing lens groups is strong, and thus it is difficult to prevent variation in various aberrations such as spherical aberration upon focusing. Furthermore, the refractive power of the front-side lens group GA is weak, and accordingly, the moving amount of the front-side lens group GA upon zooming is large, which leads to a large barrel size. It is possible to more reliably obtain the effects of the present embodiment by setting the lower limit value of the conditional expression (7) to 0.22, 0.24, 0.25, or 0.26.

The zoom optical system ZL according to the present embodiment preferably satisfies the following conditional expression (8).

1.50<|fFs|/(−fM1w)<5.00 (8)

where

fM1w: focal length of the first middle lens group GM1 in the wide-angle end state.

The conditional expression (8) defines an appropriate relation between the focal length of the focusing lens group having the strongest refractive power among the focusing lens groups included in the succeeding lens group GR and the focal length of the first middle lens group GM1 in the wide-angle end state. It is possible to prevent variation in various aberrations such as spherical aberration upon focusing by satisfying the conditional expression (8). Moreover, it is possible to excellently correct various aberrations such as coma aberration in the wide-angle end state.

When the correspondence value of the conditional expression (8) is equal to or larger than the upper limit value, the refractive power of the first middle lens group GM1 in the wide-angle end state is strong, and thus it is difficult to correct various aberrations such as coma aberration in the wide-angle end state. It is possible to more reliably obtain the effects of the present embodiment by setting the upper limit value of the conditional expression (8) to 4.85, 4.70, 4.50, 4.35, 4.25, 3.85, 3.50, 3.00, or 2.50.

When the correspondence value of the conditional expression (8) is equal to or smaller than the lower limit value, the refractive power of the focusing lens groups is strong, and thus it is difficult to prevent variation in various aberrations such as spherical aberration upon focusing. It is possible to more reliably obtain the effects of the present embodiment by setting the lower limit value of the conditional expression (8) to 1.55, 1.60, 1.65, 1.70, 1.75, 1.80, or 1.83.

The zoom optical system ZL according to the present embodiment preferably satisfies the following conditional expression (9).

0.90<|fFs|/fM2w<4.00 (9)

where

fM2w: focal length of the second middle lens group GM2 in the wide-angle end state.

The conditional expression (9) defines an appropriate relation between the focal length of the focusing lens group having the strongest refractive power among the focusing lens groups included in the succeeding lens group GR and the focal length of the second middle lens group GM2 in the wide-angle end state. It is possible to prevent variation in various aberrations such as spherical aberration upon focusing by satisfying the conditional expression (9). Moreover, it is possible to excellently correct various aberrations such as coma aberration in the wide-angle end state.

When the correspondence value of the conditional expression (9) is equal to or larger than the upper limit value, the refractive power of the second middle lens group GM2 in the wide-angle end state is strong, and thus it is difficult to correct various aberrations such as coma aberration in the wide-angle end state. It is possible to more reliably obtain the effects of the present embodiment by setting the upper limit value of the conditional expression (9) to 3.80, 3.50, 3.30, 3.00, 2.80, 2.60, 2.00, 1.80, or 1.50.

When the correspondence value of the conditional expression (9) is equal to or smaller than the lower limit value, the refractive power of the focusing lens groups is strong, and thus it is difficult to prevent variation in various aberrations such as spherical aberration upon focusing. It is possible to more reliably obtain the effects of the present embodiment by setting the lower limit value of the conditional expression (9) to 0.95, 0.98, 1.00, 1.03, or 1.05.

The zoom optical system ZL according to the present embodiment preferably satisfies the following conditional expression (10).

0.20<f1/(−fRw)<5.00 (10)

where

fRw: focal length of the succeeding lens group GR in the wide-angle end state.

The conditional expression (10) defines an appropriate relation between the focal length of the front-side lens group GA and the focal length of the succeeding lens group GR in the wide-angle end state. It is possible to excellently correct various aberrations such as coma aberration in the wide-angle end state without barrel size increase by satisfying the conditional expression (10).

When the correspondence value of the conditional expression (10) is equal to or larger than the upper limit value, the refractive power of the succeeding lens group GR in the wide-angle end state is strong, and thus it is difficult to correct various aberrations such as coma aberration in the wide-angle end state. Furthermore, the refractive power of the front-side lens group GA is weak, and accordingly, the moving amount of the front-side lens group GA upon zooming is large, which leads to a large barrel size. It is possible to more reliably obtain the effects of the present embodiment by setting the upper limit value of the conditional expression (10) to 4.50, 4.00, 3.80, 3.50, 3.30, 3.00, 2.80, or 2.50.

When the correspondence value of the conditional expression (10) is equal to or smaller than the lower limit value, the refractive power of the succeeding lens group GR in the wide-angle end state is weak, and thus it is difficult to correct various aberrations such as coma aberration in the wide-angle end state. It is possible to more reliably obtain the effects of the present embodiment by setting the lower limit value of the conditional expression (10) to 0.40, 0.50, 0.60, 0.65, 0.68, or 0.70.

The zoom optical system ZL according to the present embodiment preferably satisfies the following conditional expression (11).

0.10<MTF1/MTF2<3.00 (11)

where

MTF1: absolute value of the moving amount of the first focusing lens group GF1 upon focusing from an infinity object to a short-distance object in a telephoto end state, and

MTF2: absolute value of the moving amount of a focusing lens group closest to the first focusing lens group GF1 among the other focusing lens groups upon focusing from an infinity object to a short-distance object in the telephoto end state.

The conditional expression (11) defines an appropriate relation between the moving amount of the first focusing lens group GF1 upon focusing from an infinity object to a short-distance object in the telephoto end state and the moving amount of the focusing lens group closest to the first focusing lens group GF1. It is possible to prevent variation in various aberrations such as spherical aberration upon focusing from an infinity object to a short-distance object in the telephoto end state by satisfying the conditional expression (11).

When the correspondence value of the conditional expression (11) is equal to or larger than the upper limit value, the moving amount of the first focusing lens group GF1 upon focusing from an infinity object to a short-distance object in the telephoto end state is too large, and thus it is difficult to prevent variation in various aberrations such as spherical aberration. It is possible to more reliably obtain the effects of the present embodiment by setting the upper limit value of the conditional expression (11) to 2.80, 2.50, 2.30, 2.00, 1.80, 1.65, or 1.50.

When the correspondence value of the conditional expression (11) is equal to or smaller than the lower limit value, the moving amount of the focusing lens group closest to the first focusing lens group GF1 upon focusing from an infinity object to a short-distance object in the telephoto end state is too large, and thus it is difficult to prevent variation in various aberrations such as spherical aberration. It is possible to more reliably obtain the effects of the present embodiment by setting the lower limit value of the conditional expression (11) to 0.13, 0.15, 0.18, 0.20, 0.23, or 0.25.

The zoom optical system ZL according to the present embodiment preferably satisfies the following conditional expression (12).

0.10<βF1w/βF2w<3.00 (12)

where

βF1w: combined lateral magnification of focusing lens groups positioned on the object side of a focusing lens group closest to the image side among the focusing lens groups included in the succeeding lens group GR upon focusing on an infinity object in the wide-angle end state, and

βF2w: lateral magnification of the focusing lens group closest to the image side among the focusing lens groups included in the succeeding lens group GR upon focusing on an infinity object in the wide-angle end state.

The conditional expression (12) defines an appropriate relation between the lateral magnification of the focusing lens group closest to the image side among the focusing lens groups included in the succeeding lens group GR upon focusing on an infinity object in the wide-angle end state and the combined lateral magnification of the focusing lens groups positioned on the object side of the focusing lens group closest to the image side upon focusing on an infinity object in the wide-angle end state. It is possible to prevent variation in various aberrations such as spherical aberration upon focusing from an infinity object to a short-distance object in the wide-angle end state by satisfying the conditional expression (12).

When the correspondence value of the conditional expression (12) is equal to or larger than the upper limit value, the combined lateral magnification of the focusing lens groups positioned on the object side of the focusing lens group closest to the image side upon focusing on an infinity object in the wide-angle end state is too large. Thus, it is difficult to prevent variation in various aberrations such as spherical aberration upon focusing from an infinity object to a short-distance object in the wide-angle end state. It is possible to more reliably obtain the effects of the present embodiment by setting the upper limit value of the conditional expression (12) to 2.80, 2.50, 2.30, 2.00, 1.80, 1.50, 1.30, 1.00, or 0.90.

When the correspondence value of the conditional expression (12) is equal to or smaller than the lower limit value, the lateral magnification of the focusing lens group closest to the image side upon focusing on an infinity object in the wide-angle end state is too large. Thus, it is difficult to prevent variation in various aberrations such as spherical aberration upon focusing from an infinity object to a short-distance object in the wide-angle end state. It is possible to more reliably obtain the effects of the present embodiment by setting the lower limit value of the conditional expression (12) to 0.20, 0.35, 0.50, 0.55, 0.58, or 0.60.

The zoom optical system ZL according to the present embodiment preferably satisfies the following conditional expression (13).

0.10<βF1t/βF2t<3.00 (13)

where

βF1t: combined lateral magnification of focusing lens groups positioned on the object side of the focusing lens group closest to the image side among the focusing lens groups included in the succeeding lens group GR upon focusing on an infinity object in the telephoto end state, and

βF2t: lateral magnification of the focusing lens group closest to the image side among the focusing lens groups included in the succeeding lens group GR upon focusing on an infinity object in the telephoto end state.

The conditional expression (13) defines an appropriate relation between the lateral magnification of the focusing lens group closest to the image side among the focusing lens groups included in the succeeding lens group GR upon focusing on an infinity object in the telephoto end state and the combined lateral magnification of the focusing lens groups positioned on the object side of the focusing lens group closest to the image side upon focusing on an infinity object in the telephoto end state. It is possible to prevent variation in various aberrations such as spherical aberration upon focusing from an infinity object to a short-distance object in the telephoto end state by satisfying the conditional expression (13).

When the correspondence value of the conditional expression (13) is equal to or larger than the upper limit value, the combined lateral magnification of the focusing lens groups positioned on the object side of the focusing lens group closest to the image side upon focusing on an infinity object in the telephoto end state is too large. Thus, it is difficult to prevent variation in various aberrations such as spherical aberration upon focusing from an infinity object to a short-distance object in the telephoto end state. It is possible to more reliably obtain the effects of the present embodiment by setting the upper limit value of the conditional expression (13) to 2.80, 2.50, 2.30, 2.00, 1.80, 1.50, 1.30, 1.00, or 0.80.

When the correspondence value of the conditional expression (13) is equal to or smaller than the lower limit value, the lateral magnification of the focusing lens group closest to the image side upon focusing on an infinity object in the telephoto end state is too large. Thus, it is difficult to prevent variation in various aberrations such as spherical aberration upon focusing from an infinity object to a short-distance object in the telephoto end state. It is possible to more reliably obtain the effects of the present embodiment by setting the lower limit value of the conditional expression (13) to 0.13, 0.15, 0.18, 0.20, 0.23, or 0.25.

The zoom optical system ZL according to the present embodiment preferably satisfies the following conditional expression (14).

0.50<βF1w<2.60 (14)

where

βF1w: combined lateral magnification of the focusing lens groups positioned on the object side of the focusing lens group closest to the image side among the focusing lens groups included in the succeeding lens group GR upon focusing on an infinity object in the wide-angle end state.

The conditional expression (14) defines an appropriate range of the combined lateral magnification of the focusing lens groups positioned on the object side of the focusing lens group closest to the image side among the focusing lens groups included in the succeeding lens group GR upon focusing on an infinity object in the wide-angle end state. It is possible to prevent variation in various aberrations such as spherical aberration and coma aberration upon focusing by satisfying the conditional expression (14).

When the correspondence value of the conditional expression (14) is equal to or larger than the upper limit value, it is difficult to prevent variation in various aberrations upon focusing. It is possible to more reliably obtain the effects of the present embodiment by setting the upper limit value of the conditional expression (14) to 2.58, 2.55, 2.00, 1.80, 1.50, 1.30, or 1.20.

When the correspondence value of the conditional expression (14) is equal to or smaller than the lower limit value, it is difficult to prevent variation in various aberrations upon focusing. It is possible to more reliably obtain the effects of the present embodiment by setting the lower limit value of the conditional expression (14) to 0.55, 0.60, 0.65, 0.70, or 0.73.

The zoom optical system ZL according to the present embodiment preferably satisfies the following conditional expression (15).

0.20<βF2w<1.80 (15)

where

βF2w: lateral magnification of the focusing lens group closest to the image side among the focusing lens groups included in the succeeding lens group GR upon focusing on an infinity object in the wide-angle end state.

The conditional expression (15) defines an appropriate range of the lateral magnification of the focusing lens group closest to the image side among the focusing lens groups included in the succeeding lens group GR upon focusing on an infinity object in the wide-angle end state. It is possible to prevent variation in various aberrations such as spherical aberration and coma aberration upon focusing by satisfying the conditional expression (15).

When the correspondence value of the conditional expression (15) is equal to or larger than the upper limit value, it is difficult to prevent variation in various aberrations upon focusing. It is possible to more reliably obtain the effects of the present embodiment by setting the upper limit value of the conditional expression (15) to 1.78, 1.75, 1.73, 1.70, 1.68, or 1.60.

When the correspondence value of the conditional expression (15) is equal to or smaller than the lower limit value, it is difficult to prevent variation in various aberrations upon focusing. It is possible to more reliably obtain the effects of the present embodiment by setting the lower limit value of the conditional expression (15) to 0.23, 0.25, or 0.28.

The zoom optical system ZL according to the present embodiment preferably satisfies the following conditional expression (16).

{<F1w+(1/(βF1w)}⁻²≤0.25 (16)

where

βF1w: combined lateral magnification of the focusing lens groups positioned on the object side of the focusing lens group closest to the image side among the focusing lens groups included in the succeeding lens group GR upon focusing on an infinity object in the wide-angle end state.

The conditional expression (16) defines an appropriate range of the combined lateral magnification of the focusing lens groups positioned on the object side of the focusing lens group closest to the image side among the focusing lens groups included in the succeeding lens group GR upon focusing on an infinity object in the wide-angle end state. It is possible to prevent variation in various aberrations such as spherical aberration and coma aberration upon focusing by satisfying the conditional expression (16). When the correspondence value of the conditional expression (16) is equal to or larger than the upper limit value, it is difficult to prevent variation in various aberrations upon focusing.

The zoom optical system ZL according to the present embodiment preferably satisfies the following conditional expression (17).

{βF2w+(1/βF2w)}⁻²≤0.25 (17)

where

βF2w: lateral magnification of the focusing lens group closest to the image side among the focusing lens groups included in the succeeding lens group GR upon focusing on an infinity object in the wide-angle end state.

The conditional expression (17) defines an appropriate range of the lateral magnification of the focusing lens group closest to the image side among the focusing lens groups included in the succeeding lens group GR upon focusing on an infinity object in the wide-angle end state. It is possible to prevent variation in various aberrations such as spherical aberration and coma aberration upon focusing by satisfying the conditional expression (17). When the correspondence value of the conditional expression (17) is equal to or larger than the upper limit value, it is difficult to prevent variation in various aberrations upon focusing.

In the zoom optical system ZL according to the present embodiment, the succeeding lens group GR preferably includes at least one lens group disposed on the image side of the focusing lens group closest to the image side among the focusing lens groups included in the succeeding lens group GR. Accordingly, it is possible to effectively prevent variation in various aberrations such as spherical aberration upon focusing.

The zoom optical system ZL according to the present embodiment preferably satisfies the following conditional expression (18).

0.10<|fFs|/|fRF|<4.00 (18)

where

fRF: focal length of a lens group disposed side by side on the image side of a focusing lens group closest to the image side in the at least one lens group.

The conditional expression (18) defines an appropriate relation between the focal length of the focusing lens group having the strongest refractive power among the focusing lens groups included in the succeeding lens group GR and the focal length of the lens group disposed side by side on the image side of the focusing lens group closest to the image side. It is possible to prevent variation in various aberrations such as spherical aberration upon focusing by satisfying the conditional expression (18).

When the correspondence value of the conditional expression (18) is equal to or larger than the upper limit value, the refractive power of the lens group disposed side by side on the image side of the focusing lens group closest to the image side is strong, and thus it is difficult to prevent variation in various aberrations such as spherical aberration upon focusing. It is possible to more reliably obtain the effects of the present embodiment by setting the upper limit value of the conditional expression (18) to 3.80, 3.50, 3.30, 3.00, 2.80, 2.50, 2.30, 2.00, 1.50, 1.30, or 1.00.

When the correspondence value of the conditional expression (18) is equal to or smaller than the lower limit value, the refractive power of the focusing lens groups is strong, and thus it is difficult to prevent variation in various aberrations such as spherical aberration upon focusing. It is possible to more reliably obtain the effects of the present embodiment by setting the lower limit value of the conditional expression (18) to 0.13, 0.15, or 0.18.

The zoom optical system ZL according to the present embodiment preferably satisfies the following conditional expression (19).

2ωw>75.0° (19)

where

2ωw: full angle of view of the zoom optical system ZL in the wide-angle end state.

The conditional expression (19) defines an appropriate range of the full angle of view of the zoom optical system ZL in the wide-angle end state. The conditional expression (19) is preferably satisfied because a zoom optical system having a wide angle of view is obtained when the conditional expression (19) is satisfied. It is possible to more reliably obtain the effects of the present embodiment by setting the lower limit value of the conditional expression (19) to 78.0°, 80.0°, or 83.0°.

The zoom optical system ZL according to the present embodiment preferably satisfies the following conditional expression (20).

ft/fw>3.50 (20)

where

ft: focal length of the zoom optical system ZL in the telephoto end state.

The conditional expression (20) defines an appropriate relation between the focal length of the zoom optical system ZL in the telephoto end state and the focal length of the zoom optical system ZL in the wide-angle end state. The conditional expression (20) is preferably satisfied because a zoom optical system having a high zoom ratio is obtained when the conditional expression (20) is satisfied. It is possible to more reliably obtain the effects of the present embodiment by setting the lower limit value of the conditional expression (20) to 3.80, 4.00, 4.20, or 4.40.

The zoom optical system ZL according to the present embodiment preferably satisfies the following conditional expression (21).

0.10<(−fN)/fL<1.00 (21)

where

fN: focal length of a lens disposed second closest to the image side in the zoom optical system ZL, and

fL: focal length of a lens disposed closest to the image side in the zoom optical system ZL.

The conditional expression (21) defines an appropriate relation between the focal length of the lens disposed second closest to the image side in the zoom optical system ZL and the focal length of the lens disposed closest to the image side in the zoom optical system ZL. It is possible to excellently correct various aberrations such as coma aberration in the wide-angle end state by satisfying the conditional expression (21).

When the correspondence value of the conditional expression (21) is equal to or larger than the upper limit value, the refractive power of the lens disposed closest to the image side in the zoom optical system ZL is strong, and thus it is difficult to correct various aberrations such as coma aberration in the wide-angle end state. It is possible to more reliably obtain the effects of the present embodiment by setting the upper limit value of the conditional expression (21) to 0.95, 0.90, 0.85, 0.83, 0.80, 0.78, 0.75, 0.73, or 0.70.

When the correspondence value of the conditional expression (21) is equal to or smaller than the lower limit value, the refractive power of the lens disposed second closest to the image side in the zoom optical system ZL is strong, and thus it is difficult to correct various aberrations such as coma aberration in the wide-angle end state. It is possible to more reliably obtain the effects of the present embodiment by setting the lower limit value of the conditional expression (21) to 0.13, 0.15, or 0.18.

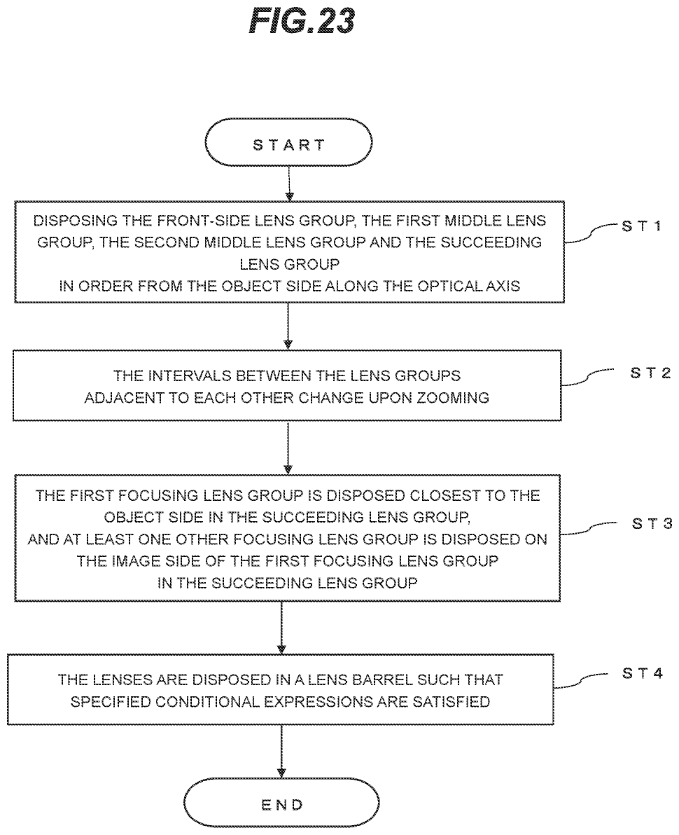

A method for manufacturing the above-described zoom optical system ZL will be generally described below with reference to FIG. 23. First, the front-side lens group GA having positive refractive power, the first middle lens group GM1 having negative refractive power, the second middle lens group GM2 having positive refractive power, and the succeeding lens group GR are disposed in order from the object side along the optical axis (step ST1). Subsequently, the lens groups are configured such that the intervals between the lens groups adjacent to each other change upon zooming (step ST2). Subsequently, the first focusing lens group GF1 configured to move along the optical axis upon focusing is disposed closest to the object side in the succeeding lens group GR, and at least one other focusing lens group configured to move along the optical axis with a locus different from that of the first focusing lens group GF1 upon focusing is disposed on the image side of the first focusing lens group GF1 in the succeeding lens group GR (step ST3). Then, lenses are disposed in a lens barrel such that at least the above-described conditional expressions (1) and (2) are satisfied (step ST4). With such a manufacturing method, it is possible to manufacture a zoom optical system with small aberration fluctuation upon focusing.

### Examples

The zoom optical systems ZL according to examples of the present embodiment will be described below with reference to the accompanying drawings. FIGS. 1, 4, 7, 10, 13, 16, and 19 are cross-sectional views illustrating the configurations and refractive power distributions of the zoom optical systems ZL {ZL(1) to ZL(7)} according to first to seventh examples. In the cross-sectional views of the zoom optical systems ZL(1) to ZL(7) according to the first to seventh examples, the moving direction of each focusing group along the optical axis upon focusing from infinity to a short-distance object is illustrated with an arrow denoted by “focusing”. In the cross-sectional views of the zoom optical systems ZL(1) to ZL(7) according to the first to seventh examples, the moving direction of each lens group along the optical axis upon zooming from the wide-angle end state (W) to the telephoto end state (T) is illustrated with an arrow.

In FIGS. 1, 4, 7, 10, 13, 16, and 19, each lens group is denoted by a combination of a reference sign “G” and a number, and each lens is denoted by a combination of a reference sign “L” and a number. In this case, each lens group or the like is denoted by using a combination of a reference sign and a number independently for each example to prevent complication due to increase in the kinds and magnitudes of reference signs and numbers. Accordingly, the same combination of a reference sign and a number in the examples does not necessarily mean identical components.

Among Tables 1 to 7 below, Table 1 is a table listing various data in the first example, Table 2 is a table listing various data in the second example, Table 3 is a table listing various data in the third example, Table 4 is a table listing various data in the fourth example, Table 5 is a table listing various data in the fifth example, Table 6 is a table listing various data in the sixth example, and Table 7 is a table listing various data in the seventh example. In each example, aberration characteristics are calculated for the d-line (wavelength λ=587.6 nm) and the g-line (wavelength λ=435.8 nm).

In each table of [General Data], f represents the focal length of the entire lens system, FNO represents the F number, 2ω represents the angle of view (in the unit of ° (degrees); co represents the half angle of view), and Ymax represents the maximum image height. In addition, TL represents a distance as the sum of BF and the distance from a lens frontmost surface to a lens rearmost surface on the optical axis upon focusing on infinity, and BF represents the distance (back focus) from the lens rearmost surface to the image surface I on the optical axis upon focusing on infinity. Note that these values are listed for each of the zoom states of the wide-angle end state (W) and the telephoto end state (T).

In each table of [General Data], the value of fM1w represents the focal length of the first middle lens group in the wide-angle end state. The value of fM2w represents the focal length of the second middle lens group in the wide-angle end state. The value of MTF1 represents the absolute value of the moving amount of the first focusing lens group upon focusing from an infinity object to a short-distance object in the telephoto end state. The value of MTF2 represents the absolute value of the moving amount of a focusing lens group closest to the first focusing lens group among the other focusing lens groups upon focusing from an infinity object to a short-distance object in the telephoto end state. The value of βF1w represents the combined lateral magnification of the focusing lens groups positioned on the object side of the focusing lens group closest to the image side among the focusing lens groups included in the succeeding lens group upon focusing on an infinity object in the wide-angle end state. The value of βF2w represents the lateral magnification of the focusing lens group closest to the image side among the focusing lens groups included in the succeeding lens group upon focusing on an infinity object in the wide-angle end state. The value of βF1t represents the combined lateral magnification of the focusing lens groups positioned on the object side of the focusing lens group closest to the image side among the focusing lens groups included in the succeeding lens group upon focusing on an infinity object in the telephoto end state. The value of βF2t represents the lateral magnification of the focusing lens group closest to the image side among the focusing lens groups included in the succeeding lens group upon focusing on an infinity object in the telephoto end state. The value of fN represents the focal length of the lens disposed second closest to the image side in the zoom optical system. The value of fL represents the focal length of a lens disposed closest to the image side in the zoom optical system. The value of fRw represents the focal length of the succeeding lens group in the wide-angle end state.

In each table of [Lens Data], a surface number represents the order of an optical surface from the object side in a direction in which a light beam proceeds, R represents the radius of curvature (defined to have a positive value for a surface having a curvature center positioned on the image side) of an optical surface, D represents a surface distance that is the distance on the optical axis from an optical surface to the next optical surface (or the image surface), nd represents the refractive index of the material of an optical member at the d-line, and vd represents the Abbe number of the material of an optical member with reference to the d-line. The symbol “∞” for the radius of curvature indicates a plane or an opening, and (Aperture Stop S) indicates an aperture stop S. Notation of the refractive index nd of air=1.00000 is omitted. When an optical surface is aspherical, the symbol “*” is attached to the surface number, and the paraxial radius of curvature is listed in the column of the radius R of curvature.

In each table of [Aspherical Surface Data], the shape of each aspherical surface listed in [Lens Data] is expressed by Expression (A) below. In the expression, X(y) represents a distance (sag amount) in the optical axis direction from a tangent plane at the apex of the aspherical surface to a position on the aspherical surface at a height y, R represents the radius of curvature (paraxial radius of curvature) of a reference spherical surface, K represents a conic constant, and Ai represents the i-th order aspherical coefficient. The notation “E-n” represents “×10⁻ⁿ”. For example, 1.234E-05 means 1.234×10⁻⁵. Note that the secondary aspherical coefficient A2 is zero, and notation thereof is omitted.

X(y)=(y²/R)/{1+(1−κ×y²/R²)^{1/2}}+A4×y⁴+A6×y⁶+A8×y⁸+A10×y¹⁰ (A)

Each table of [Variable Distance Data] lists surface distance for a surface number i of the surface distance “Di” in the table of [Lens Data]. The table of [Variable Distance Data] also lists the surface distance upon focusing on infinity and the surface distance upon focusing on a short-distance object.

Each table of [Lens Group Data] lists the starting surface (surface closest to the object side) and focal length of each lens group.

Unless otherwise stated, the unit “mm” is typically used for all data values such as the focal length f, the radius R of curvature, the surface distance D, and other lengths listed in the tables below, but each optical system can obtain equivalent optical performance when proportionally scaled up or down, and thus the values are not limited to the unit.

The above description of the tables is common to all examples, and any duplicate description is omitted below.

### First Example

The first example will be described below with reference to FIGS. 1 to 3A and 3B and Table 1. FIG. 1 is a diagram illustrating a lens configuration of the zoom optical system according to the first example. The zoom optical system ZL(1) according to the first example comprises a first lens group G1 having positive refractive power, a second lens group G2 having negative refractive power, a third lens group G3 having positive refractive power, a fourth lens group G4 having positive refractive power, a fifth lens group G5 having negative refractive power, a sixth lens group G6 having negative refractive power, and a seventh lens group G7 having positive refractive power, the lens groups being arranged in order from the object side along the optical axis. Upon zooming from the wide-angle end state (W) to the telephoto end state (T), the first to seventh lens groups G1 to G7 move to the object side along the optical axis, and the interval between the lens groups adjacent to each other changes. The aperture stop S is disposed between the second lens group G2 and the third lens group G3. Upon zooming, the aperture stop S moves along the optical axis together with the third lens group G3. Each sign (+) or (−) attached to the reference sign of a lens group represents the refractive power of the lens group, and this notation applies to all examples below as well.

The first lens group G1 consists of a cemented positive lens constituted by a negative meniscus lens L11 having a convex surface toward the object side and a positive meniscus lens L12 having a convex surface toward the object side, and a positive meniscus lens L13 having a convex surface toward the object side, the lenses being arranged in order from the object side along the optical axis.

The second lens group G2 consists of a cemented positive lens constituted by a negative meniscus lens L21 having a convex surface toward the object side, a negative meniscus lens L22 having a convex surface toward the object side, and a positive meniscus lens L23 having a convex surface toward the object side, and a negative meniscus lens L24 having a concave surface toward the object side, the lenses being arranged in order from the object side along the optical axis. The negative meniscus lens L21 has an aspherical lens surface on the object side.

The third lens group G3 is constituted by a biconvex positive lens L31. The positive lens L31 has an aspherical lens surface on the object side.

The fourth lens group G4 consists of a cemented positive lens constituted by a negative meniscus lens L41 having a convex surface toward the object side and a biconvex positive lens L42, a cemented positive lens constituted by a biconvex positive lens L43 and a negative meniscus lens L44 having a concave surface toward the object side, and a positive meniscus lens L45 having a concave surface toward the object side, the lenses being arranged in order from the object side along the optical axis. The positive meniscus lens L45 has an aspherical lens surface on the object side.

The fifth lens group G5 consists of a positive meniscus lens L51 having a concave surface toward the object side and a biconcave negative lens L52, the lens being arranged in order from the object side along the optical axis.

The sixth lens group G6 consists of a biconcave negative lens L61. The negative lens L61 has an aspherical lens surface on the object side.

The seventh lens group G7 consists of a positive meniscus lens L71 having a convex surface toward the object side. The image surface I is disposed on the image side of the seventh lens group G7.

In the present example, the first lens group G1 serves as the front-side lens group GA having positive refractive power. The second lens group G2 serves as the first middle lens group GM1 having negative refractive power. The third lens group G3 and the fourth lens group G4 serve as the second middle lens group GM2 having positive refractive power as a whole. The fifth lens group G5, the sixth lens group G6, and the seventh lens group G7 serve as the succeeding lens group GR having negative refractive power as a whole. Upon focusing from an infinity object to short-distance object, the fifth lens group G5 and the sixth lens group G6 serving as the succeeding lens group GR move toward the image side along the optical axis with loci (moving amounts) different from each other. Specifically, the fifth lens group G5 corresponds to the first focusing lens group GF1 disposed closest to the object side in the succeeding lens group GR. The sixth lens group G6 corresponds to a second focusing lens group GF2 that is another focusing lens group disposed on the image side of the first focusing lens group GF1.

Table 1 below lists data values of the zoom optical system according to the first example.

TABLE 1
[General Data]

| | |
|---|---|
| Zooming ratio = 4.74 | |
| fM1w = −17.655 | fM2w = 29.833 |
| MTF1 = 0.344 | MTF2 = 0.846 |
| βF1w = 1.071 | βF2w = 1.577 |
| βF1t = 1.111 | βF2t = 3.094 |
| fN = −38.218 | fL = 129.310 |
| fRw = −46.388 | |

| | W | M | T |
|---|---|---|---|
| f | 24.700 | 84.962 | 116.999 |
| FNO | 4.07 | 4.07 | 4.07 |
| 2ω | 85.22 | 27.40 | 20.32 |
| Ymax | 21.60 | 21.60 | 21.60 |
| TL | 128.45 | 162.37 | 178.87 |
| BF | 13.699 | 35.087 | 35.287 |

[Lens Data]

| Surface | | | | |
|---|---|---|---|---|
| Number | R | D | nd | νd |
| Object | ∞ | | | |
| Surface | | | | |
| 1 | 164.9399 | 2.000 | 1.73800 | 32.26 |
| 2 | 56.4260 | 7.579 | 1.59319 | 67.90 |
| 3 | 329.6967 | 0.200 | | |
| 4 | 61.7045 | 5.273 | 1.81600 | 46.59 |
| 5 | 267.7629 | (D5) | | |
| 6* | 242.3772 | 1.500 | 1.81600 | 46.59 |
| 7 | 16.6184 | 5.149 | | |
| 8 | 879.6675 | 1.000 | 1.58913 | 61.22 |
| 9 | 18.5708 | 4.233 | 1.95000 | 29.37 |
| 10 | 79.8132 | 2.602 | | |
| 11 | −27.5163 | 1.000 | 1.77250 | 49.62 |
| 12 | −60.4508 | (D12) | | |
| 13 | ∞ | 2.000 | | (Aperture |
| | | | | Stop S) |
| 14* | 33.9421 | 3.661 | 1.74310 | 49.44 |
| 15 | −231.3985 | (D15) | | |
| 16 | 30.3875 | 1.000 | 1.88300 | 40.66 |
| 17 | 15.6459 | 6.192 | 1.49782 | 82.57 |
| 18 | −453.7663 | 0.776 | | |
| 19 | 575.4338 | 5.622 | 1.51680 | 64.14 |
| 20 | −18.7425 | 1.000 | 2.00069 | 25.46 |
| 21 | −32.0090 | 1.264 | | |
| 22* | −70.8783 | 5.056 | 1.55332 | 71.67 |
| 23 | −21.6449 | (D23) | | |
| 24 | −90.7732 | 3.558 | 1.94595 | 17.98 |
| 25 | −39.1419 | 0.200 | | |
| 26 | −156.1339 | 1.000 | 1.90366 | 31.27 |
| 27 | 79.8952 | (D27) | | |
| 28* | −85.4924 | 1.500 | 1.81600 | 46.59 |
| 29 | 49.4815 | (D29) | | |
| 30 | 55.2902 | 3.197 | 1.90200 | 25.26 |
| 31 | 102.2388 | BF | | |
| Image | ∞ | | | |
| Surface | | | | |

[Aspherical Surface Data]

6th Surface
κ = 1.0000, A4 = 5.35995E−06, A6 = −8.27153E−09,
A8 = 2.12565E−11, A10 = −2.60526E−14
14th Surface
κ = 1.0000, A4 = −7.33442E−06, A6 = 4.81859E−09,
A8 = −4.26147E−11, A10 = −2.53196E−14
22nd Surface
κ = 1.0000, A4 = −2.36052E−05, A6 = 6.01748E−09,
A8 = 1.01789E−10, A10 = 1.24064E−13
28th Surface
κ = 1.0000, A4 = −5.15978E−06, A6 = −5.92439E−09,
A8 = 4.45911E−12, A10 = −6.10897E−15

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.000 | 31.270 | 39.333 | 2.000 | 31.270 | 39.333 |
| D12 | 17.917 | 3.226 | 2.000 | 17.917 | 3.226 | 2.000 |
| D15 | 13.739 | 3.651 | 2.000 | 13.739 | 3.651 | 2.000 |
| D23 | 6.364 | 2.978 | 2.000 | 6.466 | 3.278 | 2.344 |
| D27 | 4.416 | 6.716 | 5.540 | 5.042 | 7.231 | 6.042 |
| D29 | 3.757 | 12.879 | 26.147 | 3.029 | 12.064 | 25.302 |

[Lens Group Data]

| Group | First surface | Focal length |
|---|---|---|
| G1 | 1 | 97.130 |
| G2 | 6 | −17.655 |
| G3 | 14 | 40.069 |
| G4 | 16 | 35.478 |
| G5 | 24 | −320.573 |
| G6 | 28 | −38.218 |
| G7 | 30 | 129.310 |

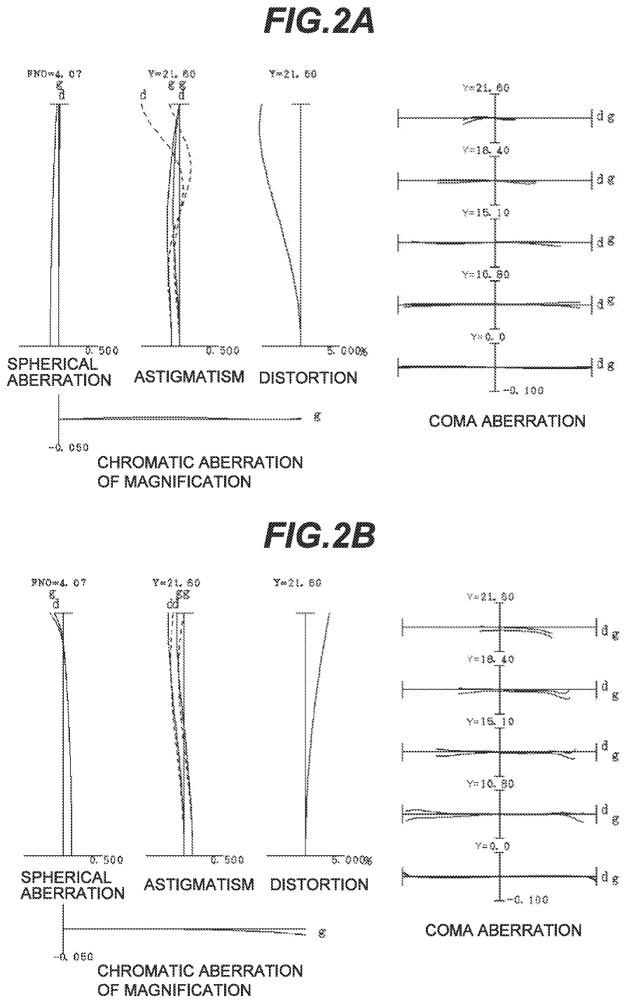

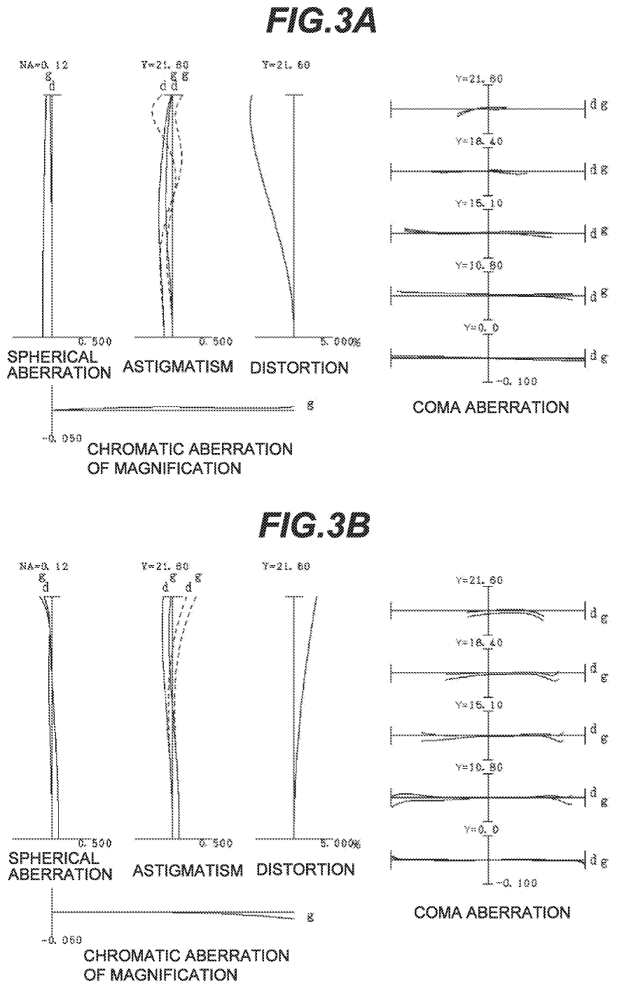

FIG. 2A illustrates various aberration diagrams of the zoom optical system according to the first example upon focusing on infinity in the wide-angle end state. FIG. 2B illustrates various aberration diagrams of the zoom optical system according to the first example upon focusing on infinity in the telephoto end state. FIG. 3A illustrates various aberration diagrams of the zoom optical system according to the first example upon focusing on a short-distance object in the wide-angle end state. FIG. 3B illustrates various aberration diagrams of the zoom optical system according to the first example upon focusing on a short-distance object in the telephoto end state. In each aberration diagram upon focusing on infinity, FNO represents the F-number, and Y represents the image height. In each aberration diagram upon focusing on a short-distance object, NA represents the numerical aperture, and Y represents the image height. Note that each spherical aberration diagram indicates the value of the F-number or numerical aperture corresponding to the maximum diameter, each astigmatism diagram and each distortion diagram indicate the maximum value of the image height, and each coma aberration diagram indicates values of the image height. In the diagrams, d represents the d-line (wavelength λ=587.6 nm), and g represent the g-line (wavelength λ=435.8 nm). In each astigmatism diagram, a solid line illustrates a sagittal image surface, and a dashed line illustrates a meridional image surface. Note that the same reference signs as in the present example are also used in the aberration diagrams of each example described below, and duplicate description thereof is omitted.

From the various aberration diagrams, it can be understood that the zoom optical system according to the first example has various aberrations excellently corrected in both the wide-angle end state and the telephoto end state not only upon focusing on infinity but also upon focusing on a short-distance object and has excellent imaging performance.

### Second Example

The second example will be described below with reference to FIGS. 4 to 6A and 6B and Table 2. FIG. 4 is a diagram illustrating a lens configuration of the zoom optical system according to the second example. The zoom optical system ZL(2) according to the second example comprises a first lens group G1 having positive refractive power, a second lens group G2 having negative refractive power, a third lens group G3 having positive refractive power, a fourth lens group G4 having positive refractive power, a fifth lens group G5 having positive refractive power, a sixth lens group G6 having negative refractive power, and a seventh lens group G7 having positive refractive power, the lens groups being arranged in order from the object side along the optical axis. Upon zooming from the wide-angle end state (W) to the telephoto end state (T), the first to seventh lens groups G1 to G7 move to the object side along the optical axis, and the interval between the lens groups adjacent to each other changes. The aperture stop S is disposed between the second lens group G2 and the third lens group G3. Upon zooming, the aperture stop S moves along the optical axis together with the third lens group G3.

The first lens group G1 consists of a cemented positive lens constituted by a negative meniscus lens L11 having a convex surface toward the object side and a positive meniscus lens L12 having a convex surface toward the object side, and a positive meniscus lens L13 having a convex surface toward the object side, the lenses being arranged in order from the object side along the optical axis.

The second lens group G2 consists of a negative meniscus lens L21 having a convex surface toward the object side, a cemented positive lens constituted by a biconcave negative lens L22 and a biconvex positive lens L23, and a negative meniscus lens L24 having a concave surface toward the object side, the lenses being arranged in order from the object side along the optical axis. The negative meniscus lens L21 has an aspherical lens surface on the object side.

The third lens group G3 consists of a positive meniscus lens L31 having a convex surface toward the object side, a biconvex positive lens L32, a cemented positive lens constituted by a negative meniscus lens L33 having a convex surface toward the object side and a biconvex positive lens L34, and a negative meniscus lens L35 having a concave surface toward the object side, the lenses being arranged in order from the object side along the optical axis.

The fourth lens group G4 consists of a cemented positive lens constituted by a negative meniscus lens L41 having a convex surface toward the object side and a biconvex positive lens L42.

The fifth lens group G5 consists of a biconcave negative lens L51, and a cemented positive lens constituted by a biconvex positive lens L52 and a negative meniscus lens L53 having a concave surface toward the object side, the lens being arranged in order from the object side along the optical axis. The negative meniscus lens L53 has an aspherical lens surface on the image side.

The sixth lens group G6 consists of a biconcave negative lens L61. The negative lens L61 has an aspherical lens surface on the object side.

The seventh lens group G7 consists of a biconvex positive lens L71. The image surface I is disposed on the image side of the seventh lens group G7.

In the present example, the first lens group G1 serves as the front-side lens group GA having positive refractive power. The second lens group G2 serves as the first middle lens group GM1 having negative refractive power. The third lens group G3 and the fourth lens group G4 serve as the second middle lens group GM2 having positive refractive power as a whole. The fifth lens group G5, the sixth lens group G6, and the seventh lens group G7 serve as the succeeding lens group GR having negative refractive power as a whole. Upon focusing from an infinity object to short-distance object, the fifth lens group G5 serving as the succeeding lens group GR moves to the object side along the optical axis, and the sixth lens group G6 serving as the succeeding lens group GR moves to the image side along the optical axis. Specifically, the fifth lens group G5 corresponds to the first focusing lens group GF1 disposed closest to the object side in the succeeding lens group GR. The sixth lens group G6 corresponds to the second focusing lens group GF2 that is another focusing lens group disposed on the image side of the first focusing lens group GF1.

Table 2 below lists data values of the zoom optical system according to the second example.

TABLE 2
[General Data]

| | |
|---|---|
| Zooming ratio = 4.74 | |
| fM1w = −17.052 | fM2w = 29.062 |
| MTF1 = 0.279 | MTF2 = 0.983 |
| βF1w = 1.045 | βF2w = 1.670 |
| βF1t = 1.038 | βF2t = 3.943 |
| fN = −31.580 | fL = 78.519 |
| fRw = −61.009 | |

| | W | M | T |
|---|---|---|---|
| f | 24.700 | 69.988 | 117.001 |
| FNO | 4.06 | 4.06 | 4.07 |
| 2ω | 85.22 | 33.90 | 20.18 |
| Ymax | 21.60 | 21.60 | 21.60 |
| TL | 134.46 | 162.88 | 189.46 |
| BF | 11.455 | 31.812 | 35.779 |

[Lens Data]

| Surface | | | | |
|---|---|---|---|---|
| Number | R | D | nd | νd |
| Object | ∞ | | | |
| Surface | | | | |
| 1 | 158.1192 | 2.000 | 1.73800 | 32.36 |
| 2 | 69.8101 | 6.421 | 1.59319 | 67.90 |
| 3 | 308.6050 | 0.200 | | |
| 4 | 66.9111 | 5.695 | 1.81600 | 46.59 |
| 5 | 207.3443 | (D5) | | |
| 6* | 78.5237 | 1.500 | 1.81600 | 46.59 |
| 7 | 16.7218 | 5.684 | | |
| 8 | −172.8187 | 1.000 | 1.80400 | 46.60 |
| 9 | 21.0165 | 4.905 | 1.90200 | 25.26 |
| 10 | −209.4912 | 1.624 | | |
| 11 | −33.2740 | 1.000 | 1.81600 | 46.59 |
| 12 | −156.9568 | (D12) | | |
| 13 | ∞ | 2.000 | | (Aperture |
| | | | | Stop S) |
| 14 | 37.1973 | 2.686 | 1.80518 | 25.45 |
| 15 | 73.4737 | 0.200 | | |
| 16 | 49.8914 | 3.509 | 1.59319 | 67.90 |
| 17 | −304.2612 | 0.200 | | |
| 18 | 35.7712 | 1.000 | 1.84850 | 43.79 |
| 19 | 16.8712 | 7.999 | 1.59319 | 67.90 |
| 20 | −57.2564 | 1.355 | | |
| 21 | −36.5767 | 1.000 | 2.00069 | 25.46 |
| 22 | −90.8325 | (D22) | | |
| 23 | 39.2071 | 1.000 | 2.00069 | 25.46 |
| 24 | 25.6545 | 6.685 | 1.59319 | 67.90 |
| 25 | −38.5079 | (D25) | | |
| 26 | −38.3881 | 1.000 | 1.94595 | 17.98 |
| 27 | 96.5319 | 0.415 | | |
| 28 | 37.3704 | 7.406 | 1.89286 | 20.36 |
| 29 | −30.3636 | 1.000 | 1.68893 | 31.16 |
| 30* | −185.8364 | (D30) | | |
| 31* | −42.4996 | 1.500 | 1.81600 | 46.59 |
| 32 | 66.5016 | (D32) | | |
| 33 | 148.1143 | 4.377 | 1.89286 | 20.36 |
| 34 | −131.2552 | BF | | |
| Image | ∞ | | | |
| Surface | | | | |

[Aspherical Surface Data]

6th Surface
κ = 1.0000, A4 = 1.23369E−06, A6 = −3.23247E−09,
A8 = −1.36560E−12, A10 = 3.42111E−15
30th Surface
κ = 1.0000, A4 = 2.14045E−05, A6 = −7.56199E−10,
A8 = −2.61800E−11, A10 = 1.98882E−13
31st Surface
κ = 1.0000, A4 = −3.01641E−06, A6 = −1.16781E−08,
A8 = −5.08849E−11, A10 = 3.00363E−13

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.000 | 26.048 | 41.130 | 2.000 | 26.048 | 41.130 |
| D12 | 21.130 | 5.163 | 2.000 | 21.130 | 5.163 | 2.000 |
| D22 | 12.345 | 4.345 | 2.000 | 12.345 | 4.345 | 2.000 |
| D25 | 2.023 | 7.035 | 9.889 | 2.000 | 6.858 | 9.610 |
| D30 | 7.665 | 6.668 | 3.602 | 8.357 | 7.660 | 4.865 |
| D32 | 4.476 | 8.453 | 21.695 | 3.807 | 7.637 | 20.712 |

[Lens Group Data]

| Group | First surface | Focal length |
|---|---|---|
| G1 | 1 | 111.149 |
| G2 | 6 | −17.052 |
| G3 | 14 | 34.545 |
| G4 | 23 | 40.961 |
| G5 | 26 | 915.545 |
| G6 | 31 | −31.580 |
| G7 | 33 | 78.519 |

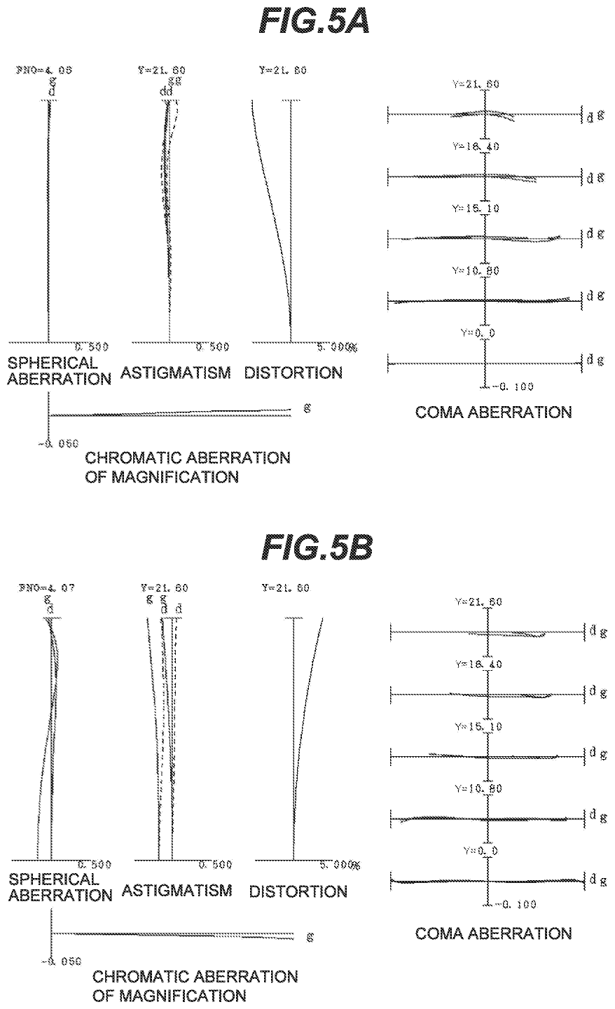

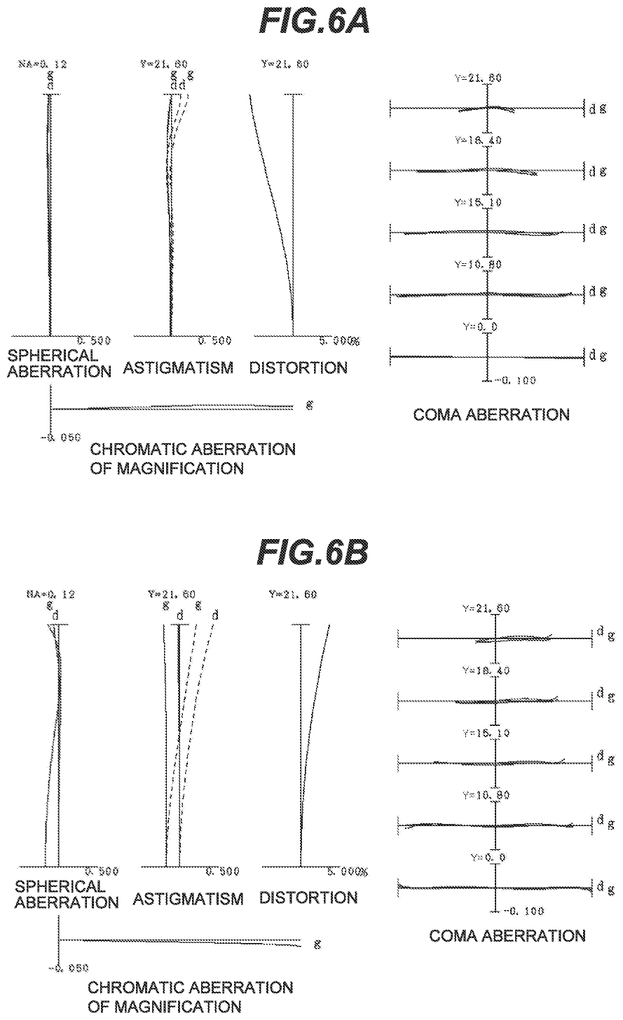

FIG. 5A illustrates various aberration diagrams of the zoom optical system according to the second example upon focusing on infinity in the wide-angle end state. FIG. 5B illustrates various aberration diagrams of the zoom optical system according to the second example upon focusing on infinity in the telephoto end state. FIG. 6A illustrates various aberration diagrams of the zoom optical system according to the second example upon focusing on a short-distance object in the wide-angle end state. FIG. 6B illustrates various aberration diagrams of the zoom optical system according to the second example upon focusing on a short-distance object in the telephoto end state. From the various aberration diagrams, it can be understood that the zoom optical system according to the second example has various aberrations excellently corrected in both the wide-angle end state and the telephoto end state not only upon focusing on infinity but also upon focusing on a short-distance object and has excellent imaging performance.

### Third Example

The third example will be described below with reference to FIGS. 7 to 9A and 9B and Table 3. FIG. 7 is a diagram illustrating a lens configuration of the zoom optical system according to the third example. The zoom optical system ZL(3) according to the third example comprises a first lens group G1 having positive refractive power, a second lens group G2 having negative refractive power, a third lens group G3 having positive refractive power, a fourth lens group G4 having positive refractive power, a fifth lens group G5 having positive refractive power, the sixth lens group G6 having positive refractive power, and the seventh lens group G7 having negative refractive power, the lens groups being arranged in order from the object side along the optical axis. Upon zooming from the wide-angle end state (W) to the telephoto end state (T), the first to seventh lens groups G1 to G7 move to the object side along the optical axis, and the interval between the lens groups adjacent to each other changes. The aperture stop S is disposed between the second lens group G2 and the third lens group G3. Upon zooming, the aperture stop S moves along the optical axis together with the third lens group G3.

The first lens group G1 consists of a cemented positive lens constituted by a plano-concave negative lens L11 shape having a flat surface on the object side and a biconvex positive lens L12, and a positive meniscus lens L13 having a convex surface toward the object side, the lens being arranged in order from the object side along the optical axis.

The second lens group G2 consists of a negative meniscus lens L21 having a convex surface toward the object side, a cemented positive lens constituted by a biconcave negative lens L22 and a biconvex positive lens L23, and a plano-concave negative lens L24 having a flat surface on the image side, the lenses being arranged in order from the object side along the optical axis. The negative meniscus lens L21 has an aspherical lens surface on the object side.

The third lens group G3 consists of a positive meniscus lens L31 having a convex surface toward the object side, a biconvex positive lens L32, and a negative meniscus lens L33 having a concave surface toward the object side, the lenses being arranged in order from the object side along the optical axis. The positive meniscus lens L31 has an aspherical lens surface on the object side.

The fourth lens group G4 consists of a biconvex positive lens L41, and a cemented positive lens constituted by a negative meniscus lens L42 having a convex surface toward the object side and a biconvex positive lens L43, the lens being arranged in order from the object side along the optical axis.

The fifth lens group G5 consists of a negative meniscus lens L51 having a concave surface toward the object side, and a biconvex positive lens L52, the lens being arranged in order from the object side along the optical axis.

The sixth lens group G6 consists of a positive meniscus lens L61 having a concave surface toward the object side. The positive meniscus lens L61 has an aspherical lens surface on the image side.

The seventh lens group G7 consists of a biconcave negative lens L71, and a positive meniscus lens L72 having a convex surface toward the object side, the lens being arranged in order from the object side along the optical axis. The image surface I is disposed on the image side of the seventh lens group G7.

In the present example, the first lens group G1 serves as the front-side lens group GA having positive refractive power. The second lens group G2 serves as the first middle lens group GM1 having negative refractive power. The third lens group G3 and the fourth lens group G4 serve as the second middle lens group GM2 having positive refractive power as a whole. The fifth lens group G5, the sixth lens group G6, and the seventh lens group G7 serve as the succeeding lens group GR having negative refractive power as a whole. Upon focusing from an infinity object to short-distance object, the fifth lens group G5 and the sixth lens group G6 serving as the succeeding lens group GR move to the object side along the optical axis with loci (moving amounts) different from each other. Specifically, the fifth lens group G5 corresponds to the first focusing lens group GF1 disposed closest to the object side in the succeeding lens group GR. The sixth lens group G6 corresponds to the second focusing lens group GF2 that is another focusing lens group disposed on the image side of the first focusing lens group GF1.

Table 3 below lists data values of the zoom optical system according to the third example.

TABLE 3
[General Data]

| | |
|---|---|
| Zooming ratio = 4.56 | |
| fM1w = −21.004 | fM2w = 33.500 |
| MTF1 = 1.413 | MTF2 = 0.980 |
| βF1w = 0.770 | βF2w = 0.954 |
| βF1t = 0.658 | βF2t = 0.946 |
| fN = −29.642 | fL = 97.753 |

fRw = −158.485

| | W | M | T |
|---|---|---|---|
| f | 22.600 | 70.008 | 103.000 |
| FNO | 4.08 | 4.08 | 4.08 |
| 2ω | 91.54 | 32.98 | 22.38 |
| Ymax | 21.60 | 21.60 | 21.60 |
| TL | 139.45 | 164.17 | 199.46 |
| BF | 11.455 | 38.439 | 39.811 |

[Lens Data]

| Surface | | | | |
|---|---|---|---|---|
| Number | R | D | nd | νd |
| Object | ∞ | | | |
| Surface | | | | |
| 1 | ∞ | 2.000 | 1.84666 | 23.80 |
| 2 | 205.3318 | 6.252 | 1.59319 | 67.90 |
| 3 | −265.8961 | 0.200 | | |
| 4 | 76.0378 | 4.794 | 1.77250 | 49.62 |
| 5 | 155.1941 | (D5) | | |
| 6* | 118.3890 | 1.500 | 1.74389 | 49.53 |
| 7 | 19.9637 | 7.065 | | |
| 8 | −66.8860 | 1.000 | 1.59319 | 67.90 |
| 9 | 24.3441 | 6.322 | 1.68893 | 31.16 |
| 10 | −44.9916 | 0.573 | | |
| 11 | −35.2853 | 1.000 | 1.81600 | 46.59 |
| 12 | ∞ | (D12) | | |
| 13 | ∞ | 2.000 | | (Aperture |
| | | | | Stop S) |
| 14* | 53.1253 | 2.930 | 1.69343 | 53.30 |
| 15 | 3836.4092 | 0.200 | | |
| 16 | 51.4447 | 4.772 | 1.59319 | 67.90 |
| 17 | −49.9261 | 2.897 | | |
| 18 | −36.2339 | 1.000 | 1.83481 | 42.73 |
| 19 | −1562.5863 | (D19) | | |
| 20 | 41.8346 | 4.903 | 1.59319 | 67.90 |
| 21 | −69.8682 | 0.200 | | |
| 22 | 94.4862 | 1.000 | 1.81600 | 46.59 |
| 23 | 19.6322 | 7.665 | 1.49782 | 82.57 |
| 24 | −56.1775 | (D24) | | |
| 25 | −29.1264 | 1.000 | 1.90200 | 25.26 |
| 26 | −57.1334 | 2.304 | | |
| 27 | 93.4868 | 5.411 | 1.80400 | 46.60 |
| 28 | −48.3174 | (D28) | | |
| 29 | −85.5900 | 1.691 | 1.77387 | 47.25 |
| 30* | −67.1935 | (D30) | | |
| 31 | −56.6426 | 1.000 | 1.83481 | 42.73 |
| 32 | 44.2945 | 2.378 | | |
| 33 | 64.6533 | 3.175 | 1.94595 | 17.98 |
| 34 | 209.7975 | BF | | |
| Image | ∞ | | | |
| Surface | | | | |

[Aspherical Surface Data]

6th Surface
κ = 1.0000, A4 = 2.28381E−06, A6 = −1.46352E−09,
A8 = −1.25256E−12, A10 = 5.36019E−15
14th Surface
κ = 1.0000, A4 = −2.87497E−06, A6 = 1.67465E−09,
A8 = −4.38683E−12, A10 = −1.60647E−15
30th Surface
κ = 1.0000, A4 = 9.04034E−06, A6 = 8.01114E−10,
A8 = 6.16585E−12, A10 = −1.63681E−14

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.000 | 16.912 | 51.168 | 2.000 | 16.912 | 51.168 |
| D12 | 23.202 | 2.589 | 2.000 | 23.202 | 2.589 | 2.000 |
| D19 | 10.189 | 2.436 | 2.000 | 10.189 | 2.436 | 2.000 |
| D24 | 5.554 | 14.413 | 18.443 | 4.619 | 13.500 | 17.030 |
| D28 | 2.044 | 8.464 | 8.285 | 2.513 | 8.681 | 8.718 |
| D30 | 9.778 | 5.681 | 2.517 | 10.245 | 6.377 | 3.497 |

[Lens Group Data]

| Group | First surface | Focal length |
|---|---|---|
| G1 | 1 | 157.131 |
| G2 | 6 | −22.004 |
| G3 | 14 | 59.544 |
| G4 | 20 | 43.565 |
| G5 | 25 | 84.112 |
| G6 | 29 | 388.390 |
| G7 | 31 | −43.760 |

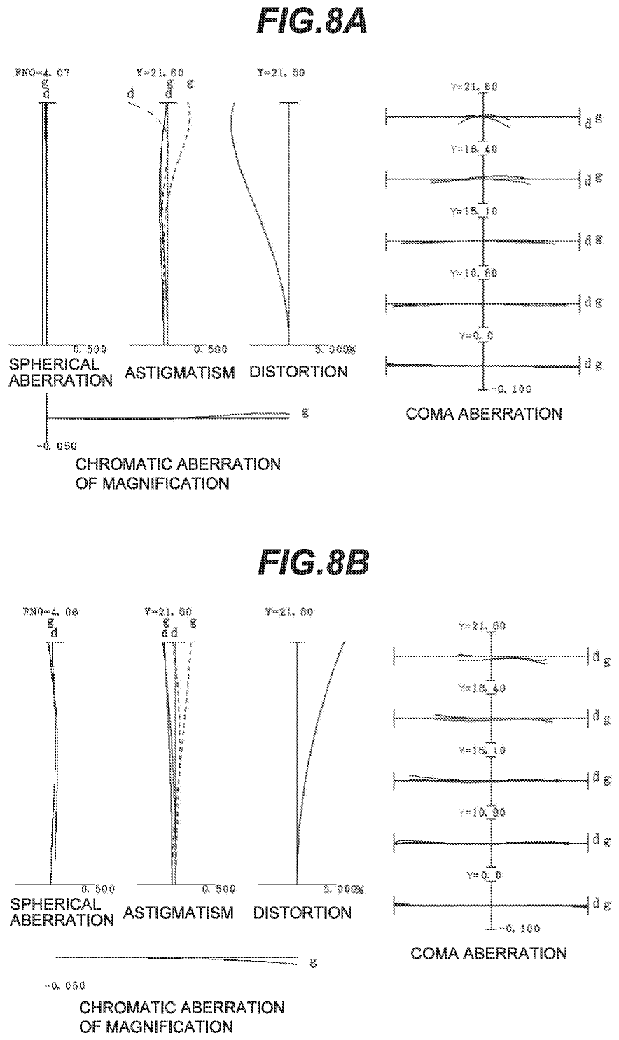

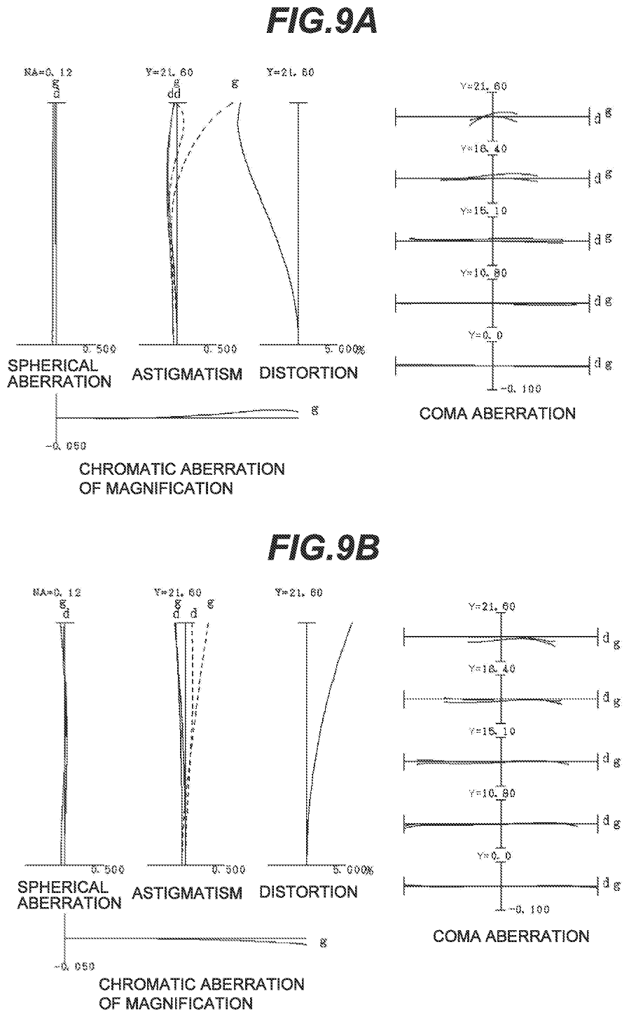

FIG. 8A illustrates various aberration diagrams of the zoom optical system according to the third example upon focusing on infinity in the wide-angle end state. FIG. 8B illustrates various aberration diagrams of the zoom optical system according to the third example upon focusing on infinity in the telephoto end state. FIG. 9A illustrates various aberration diagrams of the zoom optical system according to the third example upon focusing on a short-distance object in the wide-angle end state. FIG. 9B illustrates various aberration diagrams of the zoom optical system according to the third example upon focusing on a short-distance object in the telephoto end state. From the various aberration diagrams, it can be understood that the zoom optical system according to the third example has various aberrations excellently corrected in both the wide-angle end state and the telephoto end state not only upon focusing on infinity but also upon focusing on a short-distance object and has excellent imaging performance.

### Fourth Example

The fourth example will be described below with reference to FIGS. 10 to 12A and 12B and Table 4. FIG. 10 is a diagram illustrating a lens configuration of the zoom optical system according to the fourth example. The zoom optical system ZL(4) according to the fourth example comprises a first lens group G1 having positive refractive power, a second lens group G2 having negative refractive power, a third lens group G3 having positive refractive power, a fourth lens group G4 having positive refractive power, a fifth lens group G5 having negative refractive power, a sixth lens group G6 having negative refractive power, and a seventh lens group G7 having positive refractive power, the lens groups being arranged in order from the object side along the optical axis. Upon zooming from the wide-angle end state (W) to the telephoto end state (T), the first to sixth lens groups G1 to G6 move to the object side along the optical axis, the seventh lens group G7 temporarily moves to the object side along the optical axis and then moves to the image side, and the interval between the lens groups adjacent to each other changes. The aperture stop S is disposed between the second lens group G2 and the third lens group G3. Upon zooming, the aperture stop S moves along the optical axis together with the third lens group G3.

The first lens group G1 consists of a cemented positive lens constituted by a negative meniscus lens L11 having a convex surface toward the object side and a positive meniscus lens L12 having a convex surface toward the object side, and a positive meniscus lens L13 having a convex surface toward the object side, the lenses being arranged in order from the object side along the optical axis.

The second lens group G2 consists of a negative meniscus lens L21 having a convex surface toward the object side, a cemented positive lens constituted by a negative meniscus lens L22 having a convex surface toward the object side and a positive meniscus lens L23 having a convex surface toward the object side, and a biconcave negative lens L24, the lenses being arranged in order from the object side along the optical axis. The negative meniscus lens L21 has an aspherical lens surface on the object side.

The third lens group G3 consists of a positive meniscus lens L31 having a convex surface toward the object side, and a positive meniscus lens L32 having a convex surface toward the object side. The positive meniscus lens L31 has an aspherical lens surface on the object side.

The fourth lens group G4 consists of a cemented positive lens constituted by a negative meniscus lens L41 having a convex surface toward the object side and a biconvex positive lens L42, a cemented negative lens constituted by a biconvex positive lens L43 and a negative meniscus lens L44 having a concave surface toward the object side, and a positive meniscus lens L45 having a concave surface toward the object side, the lenses being arranged in order from the object side along the optical axis. The positive meniscus lens L45 has an aspherical lens surface on the object side.

The fifth lens group G5 consists of a biconvex positive lens L51 and a biconcave negative lens L52, the lens being arranged in order from the object side along the optical axis.

The sixth lens group G6 consists of a biconcave negative lens L61. The negative lens L61 has an aspherical lens surface on the object side.

The seventh lens group G7 consists of a positive meniscus lens L71 having a convex surface toward the object side. The image surface I is disposed on the image side of the seventh lens group G7.

In the present example, the first lens group G1 serves as the front-side lens group GA having positive refractive power. The second lens group G2 serves as the first middle lens group GM1 having negative refractive power. The third lens group G3 and the fourth lens group G4 serve as the second middle lens group GM2 having positive refractive power as a whole. The fifth lens group G5, the sixth lens group G6, and the seventh lens group G7 serve as the succeeding lens group GR having negative refractive power as a whole. Upon focusing from an infinity object to short-distance object, the fifth lens group G5 and the sixth lens group G6 serving as the succeeding lens group GR move toward the image side along the optical axis with loci (moving amounts) different from each other. Specifically, the fifth lens group G5 corresponds to the first focusing lens group GF1 disposed closest to the object side in the succeeding lens group GR. The sixth lens group G6 corresponds to the second focusing lens group GF2 that is another focusing lens group disposed on the image side of the first focusing lens group GF1.

Table 4 below lists data values of the zoom optical system according to the fourth example.

TABLE 4
[General Data]

| | |
|---|---|
| Zooming ratio = 7.85 | |
| fM1w = −17.910 | fM2w = 29.807 |
| MTF1 = 0.411 | MTF2 = 0.952 |
| βF1w = 1.005 | βF2w = 1.561 |
| βF1t = 1.019 | βF2t = 3.610 |
| fN = −35.994 | fL = 170.661 |
| fRw = −44.489 | |

| | W | M | T |
|---|---|---|---|
| f | 24.700 | 104.937 | 194.000 |
| FNO | 4.02 | 5.60 | 6.42 |
| 2ω | 85.20 | 22.32 | 12.46 |
| Ymax | 21.60 | 21.60 | 21.60 |
| TL | 130.17 | 173.77 | 204.45 |
| BF | 12.455 | 42.064 | 38.864 |

[Lens Data]

| Surface | | | | |
|---|---|---|---|---|
| Number | R | D | nd | νd |
| Object | ∞ | | | |
| Surface | | | | |
| 1 | 143.1350 | 2.000 | 1.73800 | 32.33 |
| 2 | 54.4612 | 7.561 | 1.59319 | 67.90 |
| 3 | 300.0372 | 0.200 | | |
| 4 | 69.5685 | 5.062 | 1.77250 | 49.62 |
| 5 | 409.0849 | (D5) | | |
| 6* | 350.7774 | 1.500 | 1.88202 | 37.22 |
| 7 | 18.4546 | 4.874 | | |
| 8 | 680.4222 | 1.000 | 1.49782 | 82.57 |
| 9 | 19.1843 | 4.572 | 1.85000 | 27.03 |
| 10 | 106.5036 | 1.893 | | |
| 11 | −45.6629 | 1.000 | 1.77250 | 49.62 |
| 12 | 1027.7309 | (D12) | | |
| 13 | ∞ | 2.000 | | (Aperture |
| | | | | Stop S) |
| 14* | 29.9260 | 2.529 | 1.67798 | 54.89 |
| 15 | 104.6758 | 0.200 | | |
| 16 | 37.9415 | 1.902 | 1.80809 | 22.74 |
| 17 | 50.9616 | (D17) | | |
| 18 | 24.4645 | 1.758 | 1.90265 | 35.77 |
| 19 | 14.5575 | 6.153 | 1.49782 | 82.57 |
| 20 | −102.7198 | 0.611 | | |
| 21 | 1507.9760 | 4.275 | 1.51680 | 64.13 |
| 22 | −24.0428 | 1.000 | 2.00069 | 25.46 |
| 23 | −87.8436 | 0.355 | | |
| 24* | −128.1468 | 4.545 | 1.55332 | 71.68 |
| 25 | −20.7344 | (D25) | | |
| 26 | 738.8688 | 4.696 | 1.80809 | 22.74 |
| 27 | −32.2613 | 0.200 | | |
| 28 | −47.0892 | 1.000 | 1.81600 | 46.59 |
| 29 | 81.3412 | (D29) | | |
| 30* | −59.9653 | 1.500 | 1.77387 | 47.25 |
| 31 | 52.5852 | (D31) | | |
| 32 | 51.1837 | 3.083 | 1.68893 | 31.16 |
| 33 | 88.4174 | BF | | |
| Image | ∞ | | | |
| Surface | | | | |

[Aspherical Surface Data]

6th Surface
κ = 1.0000, A4 = 3.16658E−06, A6 = −5.96049E−09,
A8 = 1.61416E−11, A10 = −2.62532E−14
14th Surface
κ = 1.0000, A4 = −7.64081E−06, A6 = −1.02540E−08,
A8 = 8.93373E−11, A10 = −6.51264E−13
24th Surface
κ = 1.0000, A4 = −3.12885E−05, A6 = 3.71787E−08,
A8 = −1.70544E−10, A10 = 1.40544E−12
30th Surface
κ = 1.0000, A4 = −5.46471E−06, A6 = −2.65649E−0,
A8 = 1.47492E−10, A10 = −2.98216E−13

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.010 | 35.817 | 51.220 | 2.010 | 35.817 | 51.220 |
| D12 | 21.188 | 4.932 | 2.030 | 21.188 | 4.932 | 2.030 |
| D17 | 13.539 | 4.497 | 2.000 | 13.539 | 4.497 | 2.000 |
| D25 | 7.124 | 3.715 | 2.000 | 7.265 | 4.018 | 2.411 |
| D29 | 4.593 | 6.548 | 4.486 | 5.167 | 7.059 | 5.027 |
| D31 | 3.794 | 10.730 | 38.386 | 3.078 | 9.916 | 37.434 |

[Lens Group Data]

| Group | First surface | Focal length |
|---|---|---|
| G1 | 1 | 103.273 |
| G2 | 6 | −17.910 |
| G3 | 14 | 44.938 |
| G4 | 18 | 37.783 |
| G5 | 26 | −980.001 |
| G6 | 30 | −35.994 |
| G7 | 32 | 170.661 |

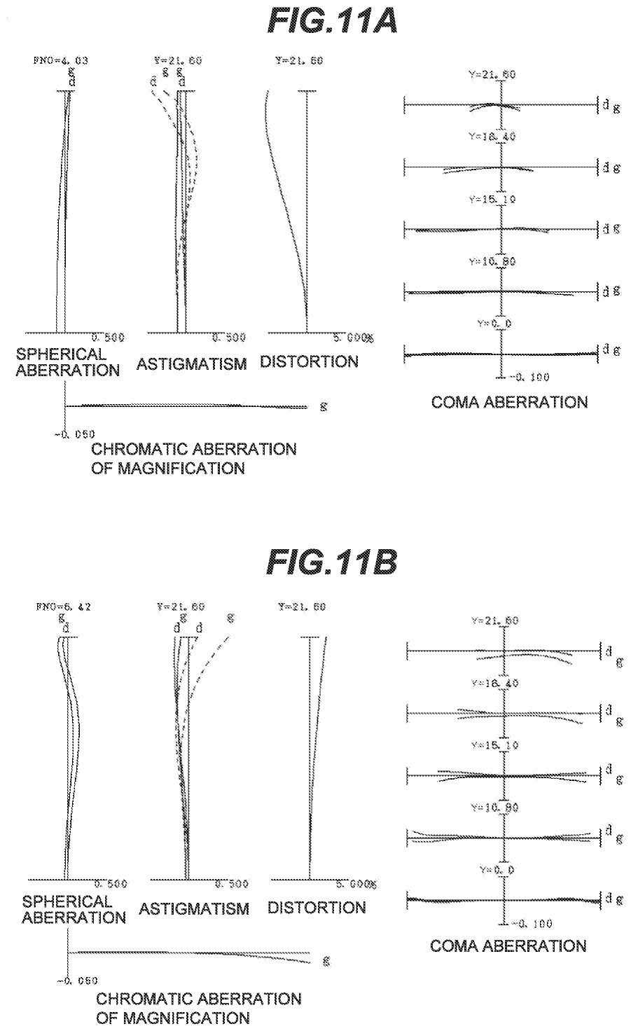

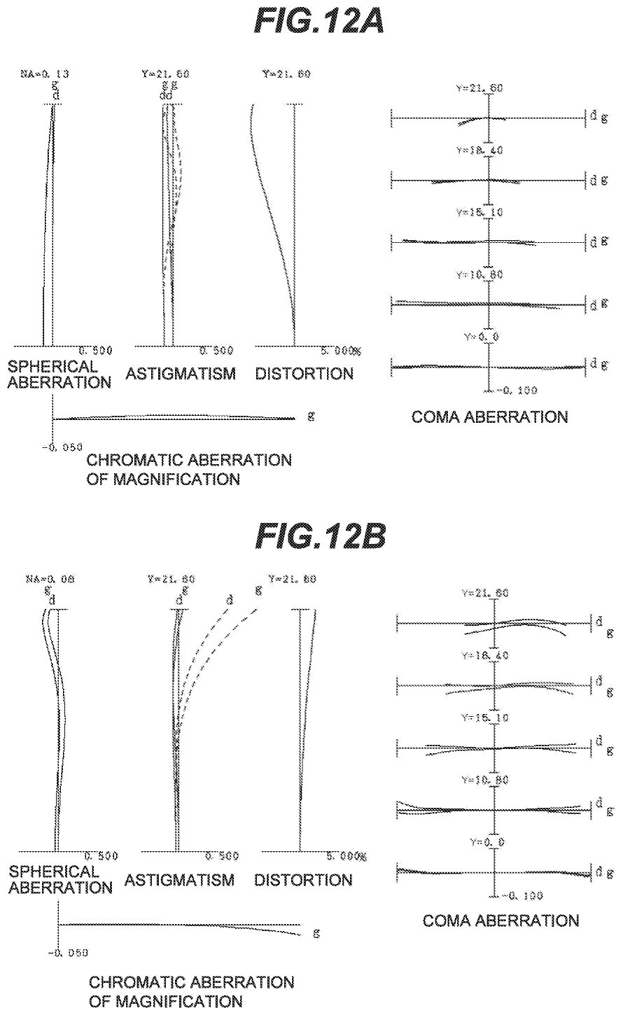

FIG. 11A illustrates various aberration diagrams of the zoom optical system according to the fourth example upon focusing on infinity in the wide-angle end state. FIG. 11B illustrates various aberration diagrams of the zoom optical system according to the fourth example upon focusing on infinity in the telephoto end state. FIG. 12A illustrates various aberration diagrams of the zoom optical system according to the fourth example upon focusing on a short-distance object in the wide-angle end state. FIG. 12B illustrates various aberration diagrams of the zoom optical system according to the fourth example upon focusing on a short-distance object in the telephoto end state. From the various aberration diagrams, it can be understood that the zoom optical system according to the fourth example has various aberrations excellently corrected in both the wide-angle end state and the telephoto end state not only upon focusing on infinity but also upon focusing on a short-distance object and has excellent imaging performance.

### Fifth Example

The fifth example will be described below with reference to FIGS. 13 to 15A and 15B and Table 5. FIG. 13 is a diagram illustrating a lens configuration of the zoom optical system according to the fifth example. The zoom optical system ZL(5) according to the fifth example comprises a first lens group G1 having positive refractive power, a second lens group G2 having negative refractive power, a third lens group G3 having negative refractive power, a fourth lens group G4 having positive refractive power, a fifth lens group G5 having positive refractive power, a sixth lens group G6 having negative refractive power, a seventh lens group G7 having negative refractive power, and an eighth lens group G8 having positive refractive power, the lens groups being arranged in order from the object side along the optical axis. Upon zooming from the wide-angle end state (W) to the telephoto end state (T), the first to seventh lens groups G1 to G7 move to the object side along the optical axis, the eighth lens group G8 temporarily moves to the object side along the optical axis and then moves to the image side, and the interval between the lens groups adjacent to each other changes. The aperture stop S is disposed between the third lens group G3 and the fourth lens group G4. Upon zooming, the aperture stop S moves along the optical axis together with the fourth lens group G4.

The first lens group G1 consists of a cemented positive lens constituted by a negative meniscus lens L11 having a convex surface toward the object side and a positive meniscus lens L12 having a convex surface toward the object side, and a positive meniscus lens L13 having a convex surface toward the object side, the lenses being arranged in order from the object side along the optical axis.

The second lens group G2 consists of a biconcave negative lens L21, and a cemented positive lens constituted by a negative meniscus lens L22 having a convex surface toward the object side and a positive meniscus lens L23 having a convex surface toward the object side, the lens being arranged in order from the object side along the optical axis. The negative lens L21 has an aspherical lens surface on the object side.

The third lens group G3 consists of a biconcave negative lens L31.

The fourth lens group G4 consists of a positive meniscus lens L41 having a convex surface toward the object side, and a positive meniscus lens L42 having a convex surface toward the object side, the lenses being arranged in order from the object side along the optical axis. The positive meniscus lens L41 has an aspherical lens surface on the object side.

The fifth lens group G5 consists of a cemented positive lens constituted by a negative meniscus lens L51 having a convex surface toward the object side and a biconvex positive lens L52, a cemented negative lens constituted by a positive meniscus lens L53 having a concave surface toward the object side and a negative meniscus lens L54 having a concave surface toward the object side, and a positive meniscus lens L55 having a concave surface toward the object side, the lenses being arranged in order from the object side along the optical axis. The positive meniscus lens L55 has an aspherical lens surface on the object side.

The sixth lens group G6 consists of a biconvex positive lens L61 and a biconcave negative lens L62, the lens being arranged in order from the object side along the optical axis.

The seventh lens group G7 consists of a biconcave negative lens L71. The negative lens L71 has an aspherical lens surface on the object side.

The eighth lens group G8 consists of a positive meniscus lens L81 having a convex surface toward the object side. The image surface I is disposed on the image side of the eighth lens group G8.

In the present example, the first lens group G1 serves as the front-side lens group GA having positive refractive power. The second lens group G2 and the third lens group G3 serve as the first middle lens group GM1 having negative refractive power as a whole. The fourth lens group G4 and the fifth lens group G5 serve as the second middle lens group GM2 having positive refractive power as a whole. The sixth lens group G6, the seventh lens group G7, and the eighth lens group G8 serve as the succeeding lens group GR having negative refractive power as a whole. Upon focusing from an infinity object to short-distance object, the sixth lens group G6 and the seventh lens group G7 serving as the succeeding lens group GR move toward the image side along the optical axis with loci (moving amounts) different from each other. Thus, the sixth lens group G6 corresponds to the first focusing lens group GF1 disposed closest to the object side in the succeeding lens group GR. The seventh lens group G7 corresponds to the second focusing lens group GF2 that is another focusing lens group disposed on the image side of the first focusing lens group GF1.

Table 5 below lists data values of the zoom optical system according to the fifth example.

TABLE 5
[General Data]

| | |
|---|---|
| Zooming ratio = 7.85 | |
| fM1w = −17.295 | fM2w = 29.310 |
| MTF1 = 0.371 | MTF2 = 0.950 |
| βF1w = 1.002 | βF2w = 1.550 |
| βF1t = 1.016 | βF2t = 3.590 |
| fN = −36.530 | fL = 180.299 |
| fRw = −44.658 | |

| | W | M | T |
|---|---|---|---|
| f | 24.700 | 104.916 | 193.992 |
| FNO | 3.98 | 5.60 | 6.48 |
| 2ω | 85.20 | 22.32 | 12.46 |
| Ymax | 21.60 | 21.60 | 21.60 |
| TL | 129.45 | 174.02 | 204.45 |
| BF | 12.454 | 43.256 | 39.757 |

[Lens Data]

| Surface | | | | |
|---|---|---|---|---|
| Number | R | D | nd | νd |
| Object | ∞ | | | |
| Surface | | | | |
| 1 | 140.6369 | 2.000 | 1.73800 | 32.33 |
| 2 | 54.2993 | 7.774 | 1.59319 | 67.90 |
| 3 | 306.9344 | 0.200 | | |
| 4 | 70.1192 | 5.137 | 1.77250 | 49.62 |
| 5 | 433.0896 | (D5) | | |
| 6* | −348.9741 | 1.500 | 1.88202 | 37.22 |
| 7 | 18.5669 | 4.368 | | |
| 8 | 132.2861 | 1.000 | 1.49782 | 82.57 |
| 9 | 19.1562 | 4.619 | 1.85000 | 27.03 |
| 10 | 92.2216 | (D10) | | |
| 11 | −59.9587 | 1.000 | 1.77250 | 49.62 |
| 12 | 207.6789 | (D12) | | |
| 13 | ∞ | 2.000 | | |
| 14* | 29.0382 | 2.246 | 1.67798 | 54.89 |
| 15 | 56.3251 | 0.200 | | |
| 16 | 35.5481 | 2.153 | 1.80809 | 22.74 |
| 17 | 64.9456 | (D17) | | |
| 18 | 22.8201 | 1.147 | 1.90265 | 35.77 |
| 19 | 14.0716 | 6.794 | 1.49782 | 82.57 |
| 20 | −62.9717 | 0.250 | | |
| 21 | −578.5647 | 3.866 | 1.51680 | 64.13 |
| 22 | −26.3104 | 1.000 | 2.00069 | 25.46 |
| 23 | −262.9123 | 0.400 | | |
| 24* | −252.2011 | 4.807 | 1.55332 | 71.68 |
| 25 | −20.2354 | (D25) | | |
| 26 | 406.6131 | 4.916 | 1.80809 | 22.74 |
| 27 | −31.2178 | 0.200 | | |
| 28 | −44.1001 | 1.000 | 1.81600 | 46.59 |
| 29 | 76.8052 | (D29) | | |
| 30* | −65.9674 | 1.500 | 1.77387 | 47.25 |
| 31 | 49.9596 | (D31) | | |
| 32 | 48.7044 | 2.979 | 1.68893 | 31.16 |
| 33 | 78.1205 | BF | | |
| Image | ∞ | | | |
| Surface | | | | |

[Aspherical Surface Data]

6th Surface
κ = 1.0000, A4 = 6.01924E−06, A6 = −9.78216E−09,
A8 = 1.91188E−11, A10 = −2.54581E−14
14th Surface
κ = 1.0000, A4 = −8.67328E−06, A6 = −1.41146E−08,
A8 = 1.05557E−10, A10 = −7.15518E−13
24th Surface
κ = 1.0000, A4 = −3.58225E−05, A6 = 5.16946E−08,
A8 = −2.69722E−10, A10 = 2.25425E−12
30th Surface
κ = 1.0000, A4 = −5.04731E−06, A6 = −3.08030E−08,
A8 = 1.84868E−10, A10 = −5.03672E−13

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.591 | 35.849 | 51.107 | 2.591 | 35.849 | 51.107 |
| D10 | 2.474 | 1.925 | 1.779 | 2.474 | 1.925 | 1.779 |
| D12 | 19.518 | 4.834 | 2.144 | 19.518 | 4.834 | 2.144 |
| D17 | 13.288 | 4.561 | 2.000 | 13.288 | 4.561 | 2.000 |
| D25 | 7.742 | 3.790 | 2.000 | 7.926 | 4.060 | 2.371 |
| D29 | 4.510 | 6.280 | 4.193 | 5.056 | 6.817 | 4.772 |
| D31 | 3.824 | 10.476 | 38.417 | 3.094 | 9.669 | 37.467 |

[Lens Group Data]

| Group | First surface | Focal length |
|---|---|---|
| G1 | 1 | 101.843 |
| G2 | 6 | −28.919 |
| G3 | 11 | −60.130 |
| G4 | 14 | 45.188 |
| G5 | 18 | 37.275 |
| G6 | 26 | −979.922 |
| G7 | 30 | −36.530 |
| G8 | 32 | 180.299 |

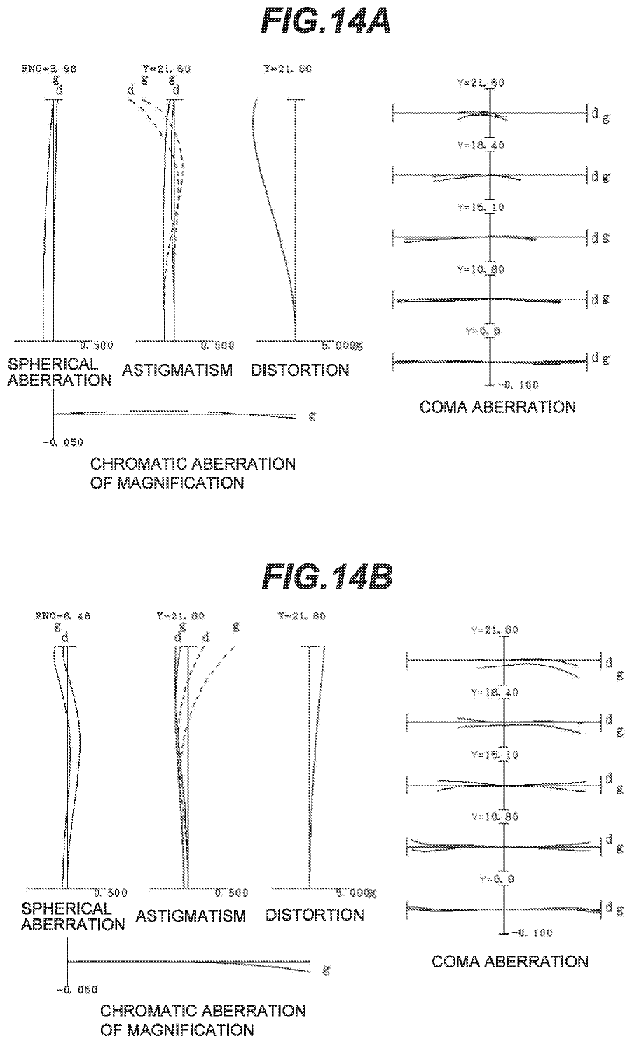

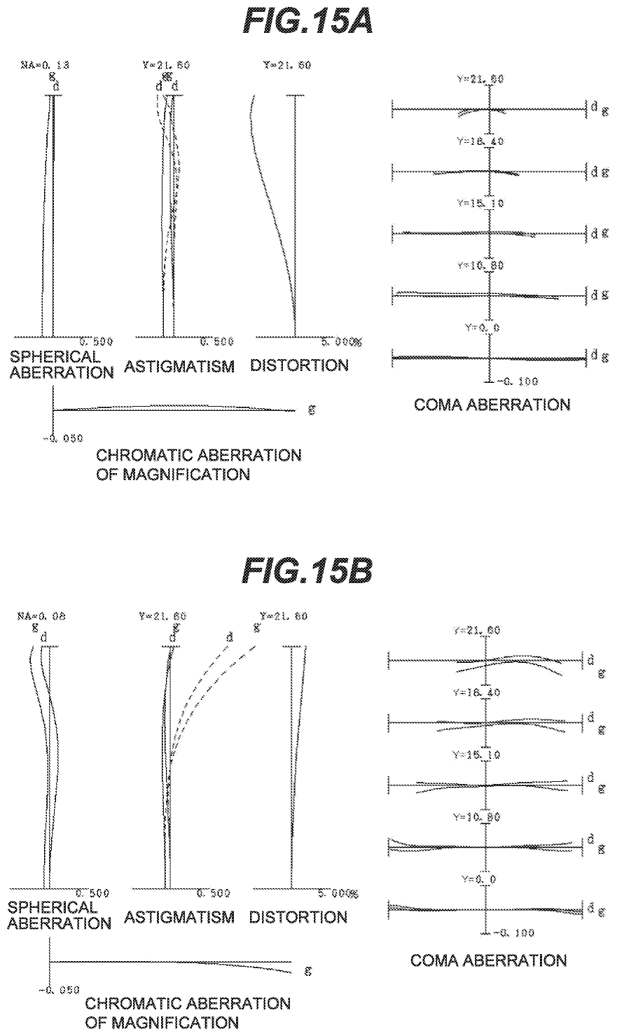

FIG. 14A illustrates various aberration diagrams of the zoom optical system according to the fifth example upon focusing on infinity in the wide-angle end state. FIG. 14B illustrates various aberration diagrams of the zoom optical system according to the fifth example upon focusing on infinity in the telephoto end state. FIG. 15A illustrates various aberration diagrams of the zoom optical system according to the fifth example upon focusing on a short-distance object in the wide-angle end state. FIG. 15B illustrates various aberration diagrams of the zoom optical system according to the fifth example upon focusing on a short-distance object in the telephoto end state. From the various aberration diagrams, it can be understood that the zoom optical system according to the fifth example has various aberrations excellently corrected in both the wide-angle end state and the telephoto end state not only upon focusing on infinity but also upon focusing on a short-distance object and has excellent imaging performance.

### Sixth Example

The sixth example will be described below with reference to FIGS. 16 to 18A and 18B and Table 6. FIG. 16 is a diagram illustrating a lens configuration of the zoom optical system according to the sixth example. The zoom optical system ZL(6) according to the sixth example comprises a first lens group G1 having positive refractive power, a second lens group G2 having negative refractive power, a third lens group G3 having positive refractive power, a fourth lens group G4 having positive refractive power, a fifth lens group G5 having negative refractive power, a sixth lens group G6 having positive refractive power, a seventh lens group G7 having positive refractive power, and an eighth lens group G8 having negative refractive power, the lens groups being arranged in order from the object side along the optical axis. Upon zooming from the wide-angle end state (W) to the telephoto end state (T), the first to eighth lens groups G1 to G8 move to the object side along the optical axis, and the interval between the lens groups adjacent to each other changes. The aperture stop S is disposed between the second lens group G2 and the third lens group G3. Upon zooming, the aperture stop S moves along the optical axis together with the third lens group G3.

The first lens group G1 consists of a cemented positive lens constituted by a negative meniscus lens L11 having a convex surface toward the object side and a biconvex positive lens L12, and a positive meniscus lens L13 having a convex surface toward the object side, the lenses being arranged in order from the object side along the optical axis.

The second lens group G2 consists of a negative meniscus lens L21 having a convex surface toward the object side, a cemented positive lens constituted by a biconcave negative lens L22 and a biconvex positive lens L23, and a biconcave negative lens L24, the lenses being arranged in order from the object side along the optical axis. The negative meniscus lens L21 has an aspherical lens surface on the object side.

The third lens group G3 consists of a positive meniscus lens L31 having a convex surface toward the object side, a biconvex positive lens L32, and a negative meniscus lens L33 having a concave surface toward the object side, the lenses being arranged in order from the object side along the optical axis. The positive meniscus lens L31 has an aspherical lens surface on the object side.

The fourth lens group G4 consists of a biconvex positive lens L41, and a cemented negative lens constituted by a negative meniscus lens L42 having a convex surface toward the object side and a biconvex positive lens L43, the lens being arranged in order from the object side along the optical axis.

The fifth lens group G5 consists of a negative meniscus lens L51 having a concave surface toward the object side.

The sixth lens group G6 consists of a biconvex positive lens L61.

The seventh lens group G7 consists of a positive meniscus lens L71 having a concave surface toward the object side. The positive meniscus lens L71 has an aspherical lens surface on the image side.

The eighth lens group G8 consists of a biconcave negative lens L81, and a positive meniscus lens L82 having a convex surface toward the object side, the lens being arranged in order from the object side along the optical axis. The image surface I is disposed on the image side of the eighth lens group G8.

In the present example, the first lens group G1 serves as the front-side lens group GA having positive refractive power. The second lens group G2 serves as the first middle lens group GM1 having negative refractive power. The third lens group G3 and the fourth lens group G4 serve as the second middle lens group GM2 having positive refractive power as a whole. The fifth lens group G5, the sixth lens group G6, and the seventh lens group G7, and the eighth lens group G8 serve as the succeeding lens group GR having negative refractive power as a whole. Upon focusing from an infinity object to short-distance object, the fifth lens group G5, the sixth lens group G6, and the seventh lens group G7 serving as the succeeding lens group GR move to the object side along the optical axis with loci (moving amounts) different from each other. Specifically, the fifth lens group G5 corresponds to the first focusing lens group GF1 disposed closest to the object side in the succeeding lens group GR. The sixth lens group G6 corresponds to the second focusing lens group GF2 that is another focusing lens group disposed on the image side of the first focusing lens group GF1. The seventh lens group G7 corresponds to the third focusing lens group GF3 that is another focusing lens group disposed on the image side of the first focusing lens group GF1.

Table 6 below lists data values of the zoom optical system according to the sixth example.

TABLE 6
[General Data]

| | |
|---|---|
| Zooming ratio = 4.70 | |
| fM1w = −19.907 | fM2w = 32.581 |
| MTF1 = 2.249 | MTF2 = 2.096 |
| βF1w = 0.765 | βF2w = 0.949 |
| βF1t = 0.684 | βF2t = 0.943 |
| fN = −37.608 | fL = 176.733 |
| fRw = −190.173 | |

| | W | M | T |
|---|---|---|---|
| f | 24.700 | 70.009 | 115.999 |
| FNO | 4.06 | 4.02 | 4.12 |
| 2ω | 86.44 | 32.64 | 19.92 |
| Ymax | 21.60 | 21.60 | 21.60 |
| TL | 139.45 | 169.68 | 199.08 |
| BF | 12.344 | 33.226 | 39.472 |

[Lens Data]

| Surface | | | | |
|---|---|---|---|---|
| Number | R | D | nd | νd |
| Object | ∞ | | | |
| Surface | | | | |
| 1 | 462.2978 | 2.000 | 1.84666 | 23.80 |
| 2 | 117.9843 | 7.772 | 1.59319 | 67.90 |
| 3 | −332.8090 | 0.200 | | |
| 4 | 68.5981 | 5.329 | 1.77250 | 49.62 |
| 5 | 140.6044 | (D5) | | |
| 6* | 102.1762 | 1.500 | 1.74389 | 49.53 |
| 7 | 20.0193 | 7.301 | | |
| 8 | −53.3166 | 1.000 | 1.59319 | 67.90 |
| 9 | 23.3630 | 6.829 | 1.68893 | 31.16 |
| 10 | −34.9416 | 0.488 | | |
| 11 | −29.8911 | 1.000 | 1.81600 | 46.59 |
| 12 | 771.9204 | (D12) | | |
| 13 | ∞ | 2.000 | | (Aperture |
| | | | | Stop S) |
| 14* | 64.5221 | 2.313 | 1.69343 | 53.30 |
| 15 | 218.6309 | 0.200 | | |
| 16 | 42.2294 | 5.148 | 1.59319 | 67.90 |
| 17 | −50.9166 | 0.846 | | |
| 18 | −38.4211 | 1.000 | 1.83481 | 42.73 |
| 19 | −121.6787 | (D19) | | |
| 20 | 50.5091 | 4.565 | 1.59319 | 67.90 |
| 21 | −73.4692 | 0.200 | | |
| 22 | 144.3902 | 1.000 | 1.81600 | 46.59 |
| 23 | 20.8080 | 7.069 | 1.49782 | 82.57 |
| 24 | −58.5658 | (D24) | | |
| 25 | −36.5746 | 1.000 | 1.90200 | 25.26 |
| 26 | −88.6629 | (D26) | | |
| 27 | 78.2651 | 5.215 | 1.80400 | 46.60 |
| 28 | −61.1685 | (D28) | | |
| 29 | −115.4337 | 1.682 | 1.77387 | 47.25 |
| 30* | −84.6141 | (D30) | | |
| 31 | −93.1742 | 1.000 | 1.83481 | 42.73 |
| 32 | 47.5819 | 1.399 | | |
| 33 | 51.8920 | 2.458 | 1.94594 | 17.98 |
| 34 | 73.5164 | BF | | |
| Image | ∞ | | | |
| Surface | | | | |

[Aspherical Surface Data]

6th Surface
κ = 1.0000, A4 = 1.46132E−06, A6 = −1.42920E−09,
A8 = 2.79764E−12, A10 = 5.33710E−15
14th Surface
κ = 1.0000, A4 = −3.76343E−06, A6 = 1.16052E−09,
A8 = −1.11309E−11, A10 = 1.96066E−14
30th Surface
κ = 1.0000, A4 = 9.30832E−06, A6 = 3.85397E−09,
A8 = −9.94633E−12, A10 = 2.27044E−14

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.000 | 24.468 | 49.503 | 2.000 | 24.468 | 49.503 |
| D12 | 20.478 | 3.818 | 2.074 | 20.478 | 3.818 | 2.074 |
| D19 | 8.916 | 3.265 | 2.000 | 8.916 | 3.265 | 2.000 |
| D24 | 6.612 | 13.356 | 22.504 | 5.023 | 11.937 | 20.255 |
| D26 | 3.664 | 3.898 | 2.010 | 3.909 | 4.002 | 2.162 |
| D28 | 3.789 | 9.856 | 8.781 | 4.421 | 10.371 | 9.746 |
| D30 | 11.138 | 7.275 | 2.224 | 11.850 | 8.075 | 3.355 |

[Lens Group Data]

| Group | First surface | Focal length |
|---|---|---|
| G1 | 1 | 134.376 |
| G2 | 6 | −19.907 |
| G3 | 14 | 53.036 |
| G4 | 20 | 55.179 |
| G5 | 25 | −69.654 |
| G6 | 27 | 43.428 |
| G7 | 29 | 399.999 |
| G8 | 31 | −47.335 |

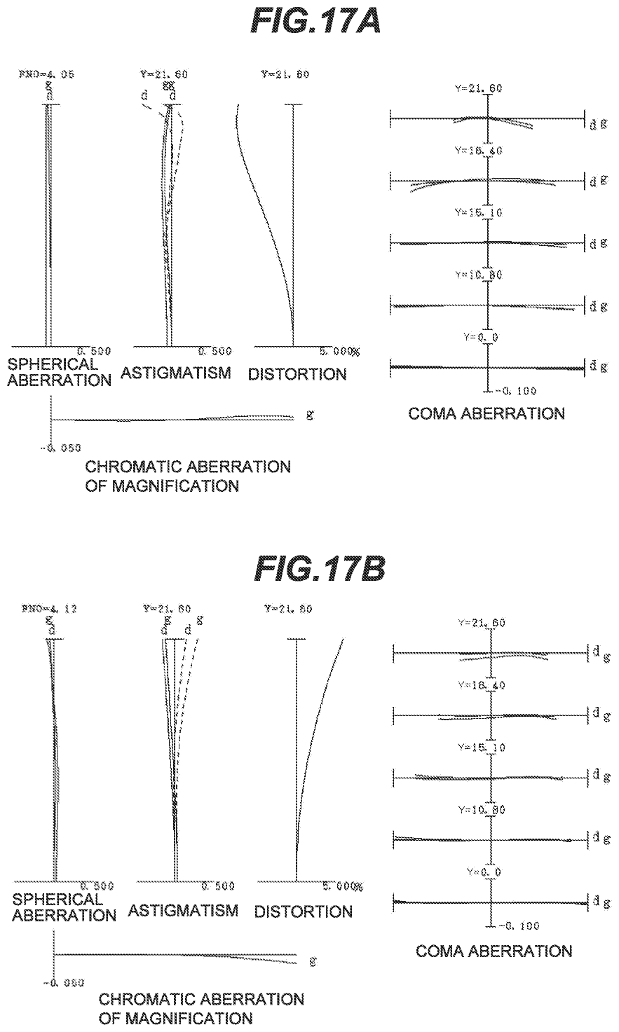

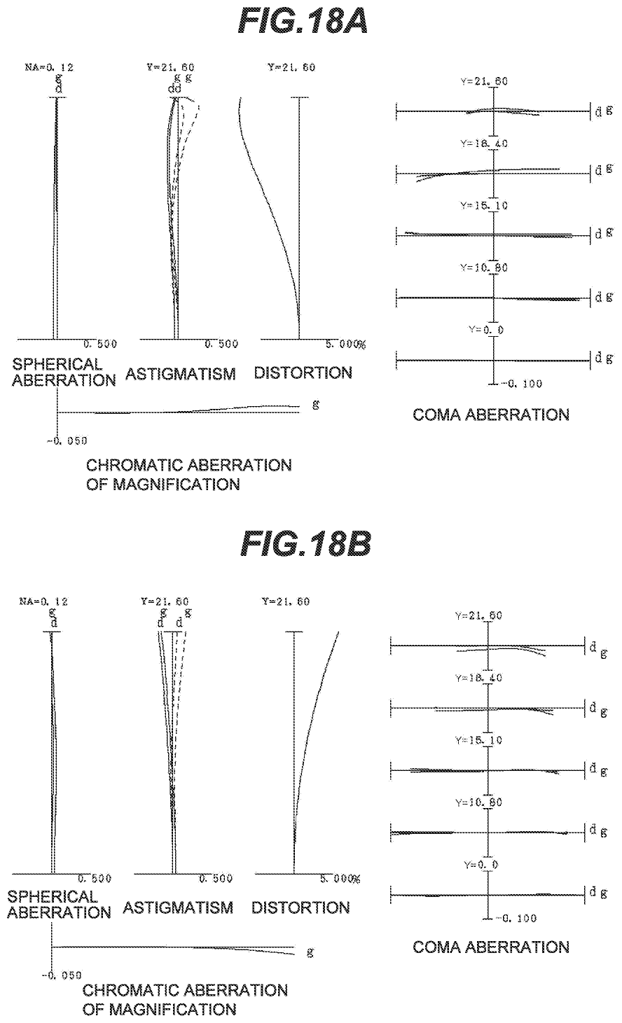

FIG. 17A illustrates various aberration diagrams of the zoom optical system according to the sixth example upon focusing on infinity in the wide-angle end state. FIG. 17B illustrates various aberration diagrams of the zoom optical system according to the sixth example upon focusing on infinity in the telephoto end state. FIG. 18A illustrates various aberration diagrams of the zoom optical system according to the sixth example upon focusing on a short-distance object in the wide-angle end state. FIG. 18B illustrates various aberration diagrams of the zoom optical system according to the sixth example upon focusing on a short-distance object in the telephoto end state. From the various aberration diagrams, it can be understood that the zoom optical system according to the sixth example has various aberrations excellently corrected in both the wide-angle end state and the telephoto end state not only upon focusing on infinity but also upon focusing on a short-distance object and has excellent imaging performance.

### Seventh Example

The seventh example will be described below with reference to FIGS. 19 to 21A and 21B and Table 7. FIG. 19 is a diagram illustrating a lens configuration of the zoom optical system according to the seventh example. The zoom optical system ZL(7) according to the seventh example comprises a first lens group G1 having positive refractive power, a second lens group G2 having negative refractive power, a third lens group G3 having positive refractive power, a fourth lens group G4 having negative refractive power, a fifth lens group G5 having positive refractive power, a sixth lens group G6 having positive refractive power, a seventh lens group G7 having positive refractive power, and an eighth lens group G8 having negative refractive power, the lens groups being arranged in order from the object side along the optical axis. Upon zooming from the wide-angle end state (W) to the telephoto end state (T), the first to eighth lens groups G1 to G8 move to the object side along the optical axis, and the interval between the lens groups adjacent to each other changes. The aperture stop S is disposed between the second lens group G2 and the third lens group G3. Upon zooming, the aperture stop S moves along the optical axis together with the third lens group G3.

The first lens group G1 consists of a cemented positive lens constituted by a negative meniscus lens L11 having a convex surface toward the object side and a biconvex positive lens L12, and a positive meniscus lens L13 having a convex surface toward the object side, the lenses being arranged in order from the object side along the optical axis.

The second lens group G2 consists of a negative meniscus lens L21 having a convex surface toward the object side, a cemented positive lens constituted by a biconcave negative lens L22 and a biconvex positive lens L23, and a plano-concave negative lens L24 having a flat surface on the image side, the lenses being arranged in order from the object side along the optical axis. The negative meniscus lens L21 has an aspherical lens surface on the object side.

The third lens group G3 consists of a biconvex positive lens L31 and a biconvex positive lens L32, the lens being arranged in order from the object side along the optical axis. The positive lens L31 has an aspherical lens surface on the object side.

The fourth lens group G4 consists of a biconcave negative lens L41.

The fifth lens group G5 consists of a biconvex positive lens L51, and a cemented positive lens constituted by a negative meniscus lens L52 having a convex surface toward the object side and a biconvex positive lens L53, the lens being arranged in order from the object side along the optical axis.

The sixth lens group G6 consists of a negative meniscus lens L61 having a concave surface toward the object side, and a biconvex positive lens L62, the lens being arranged in order from the object side along the optical axis.

The seventh lens group G7 consists of a positive meniscus lens L71 having a concave surface toward the object side. The positive meniscus lens L71 has an aspherical lens surface on the image side.

The eighth lens group G8 consists of a biconcave negative lens L81, and a positive meniscus lens L82 having a convex surface toward the object side, the lens being arranged in order from the object side along the optical axis. The image surface I is disposed on the image side of the eighth lens group G8.

In the present example, the first lens group G1 serves as the front-side lens group GA having positive refractive power. The second lens group G2 serves as the first middle lens group GM1 having negative refractive power. The third lens group G3, the fourth lens group G4, and the fifth lens group G5 serve as the second middle lens group GM2 having positive refractive power as a whole. The sixth lens group G6, the seventh lens group G7, and the eighth lens group G8 serve as the succeeding lens group GR having negative refractive power as a whole. Upon focusing from an infinity object to short-distance object, the sixth lens group G6 and the seventh lens group G7 serving as the succeeding lens group GR move to the object side along the optical axis with loci (moving amounts) different from each other. Thus, the sixth lens group G6 corresponds to the first focusing lens group GF1 disposed closest to the object side in the succeeding lens group GR. The seventh lens group G7 corresponds to the second focusing lens group GF2 that is another focusing lens group disposed on the image side of the first focusing lens group GF1.

Table 7 below lists data values of the zoom optical system according to the seventh example.

TABLE 7
[General Data]

| | |
|---|---|
| Zooming ratio = 4.56 | |
| fM1w = −20.363 | fM2w = 33.345 |
| MTF1 = 1.381 | MTF2 = 0.984 |
| βF1w = 0.763 | βF2w = 0.948 |
| βF1t = 0.650 | βF2t = 0.940 |
| fN = −30.226 | fL = 100.683 |
| fRw = −177.170 | |

| | W | M | T |
|---|---|---|---|
| f | 22.600 | 70.004 | 103.000 |
| FNO | 4.09 | 4.09 | 4.08 |
| 2ω | 91.56 | 33.96 | 22.38 |
| Ymax | 21.60 | 21.60 | 21.60 |
| TL | 139.45 | 165.05 | 199.45 |
| BF | 11.779 | 38.577 | 39.906 |

[Lens Data]

| Surface | | | | |
|---|---|---|---|---|
| Number | R | D | nd | νd |
| Object | ∞ | | | |
| Surface | | | | |
| 1 | 6659.3699 | 2.000 | 1.84666 | 23.80 |
| 2 | 195.3556 | 6.352 | 1.59319 | 67.90 |
| 3 | −273.7600 | 0.200 | | |
| 4 | 73.6739 | 4.876 | 1.77250 | 49.62 |
| 5 | 149.1863 | (D5) | | |
| 6* | 113.0230 | 1.500 | 1.74389 | 49.53 |
| 7 | 19.5406 | 7.132 | | |
| 8 | −63.0618 | 1.000 | 1.59319 | 67.90 |
| 9 | 24.3284 | 6.267 | 1.68893 | 31.16 |
| 10 | −43.5952 | 0.573 | | |
| 11 | −34.2926 | 1.000 | 1.81600 | 46.59 |
| 12 | ∞ | (D12) | | |
| 13 | ∞ | 2.000 | | (Aperture |
| | | | | Stop S) |
| 14* | 57.8680 | 3.090 | 1.69343 | 53.30 |
| 15 | −302.2108 | 0.200 | | |
| 16 | 48.4547 | 4.785 | 1.59319 | 67.90 |
| 17 | −53.3050 | (D17) | | |
| 18 | −38.1755 | 1.000 | 1.83481 | 42.730 |
| 19 | 616.7068 | (D19) | | |
| 20 | 42.1940 | 4.851 | 1.59319 | 67.90 |
| 21 | −69.0643 | 0.200 | | |
| 22 | 98.4698 | 1.000 | 1.81600 | 46.59 |
| 23 | 19.6428 | 7.597 | 1.49782 | 82.57 |
| 24 | −56.1321 | (D24) | | |
| 25 | −29.3608 | 1.000 | 1.90200 | 25.26 |
| 26 | −58.1915 | 1.995 | | |
| 27 | 90.0589 | 5.380 | 1.80400 | 46.60 |
| 28 | −48.9540 | (D28) | | |
| 29 | −85.0115 | 1.709 | 1.77387 | 47.25 |
| 30* | −65.3126 | (D30) | | |
| 31 | −62.1123 | 1.000 | 1.83481 | 42.73 |
| 32 | 42.8077 | 3.227 | | |
| 33 | 69.1642 | 3.143 | 1.94594 | 17.98 |
| 34 | 247.0342 | BF | | |
| Image | ∞ | | | |
| Surface | | | | |

[Aspherical Surface Data]

6th Surface
κ = 1.0000, A4 = 2.33500E−06, A6 = −8.92215E−10,
A8 = −3.76442E−12, A10 = 9.61354E−15
14th Surface
κ = 1.0000, A4 = −2.41342E−06, A6 = 1.12249E−09
A8 = −3.73343E−13, A10 = −1.07003E−14
30th Surface
κ = 1.0000, A4 = 9.05002E−06, A6 = 4.53686E−10,
A8 = 5.24788E−12, A10 = −1.61841E−14

[Variable Distance Data]

| | | | | Upon focusing on a | | |
|---|---|---|---|---|---|---|
| | Upon focusing on infinity | | | short-distance object | | |
| | W | M | T | W | M | T |
| D5 | 2.000 | 17.263 | 50.507 | 2.000 | 17.263 | 50.507 |
| D12 | 22.632 | 2.617 | 2.000 | 22.632 | 2.617 | 2.000 |
| D17 | 2.327 | 2.925 | 2.897 | 2.327 | 2.925 | 2.897 |
| D19 | 10.846 | 2.372 | 2.000 | 10.846 | 2.372 | 2.000 |
| D24 | 5.406 | 14.281 | 18.351 | 4.526 | 13.387 | 16.970 |
| D28 | 2.000 | 8.343 | 8.382 | 2.443 | 8.546 | 8.779 |
| D30 | 9.389 | 5.598 | 2.334 | 9.827 | 6.289 | 3.318 |

[Lens Group Data]

| Group | First surface | Focal length |
|---|---|---|
| G1 | 1 | 153.821 |
| G2 | 6 | −20.363 |
| G3 | 14 | 27.666 |
| G4 | 18 | −43.034 |
| G5 | 20 | 44.173 |
| G6 | 25 | 84.579 |
| G7 | 29 | 350.941 |
| G8 | 31 | −44.997 |

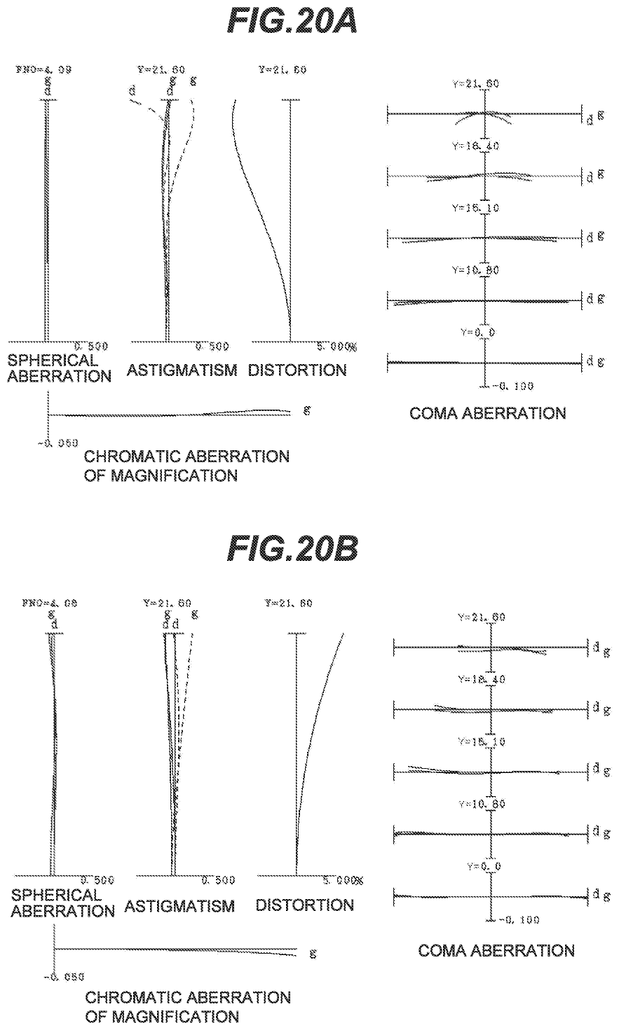

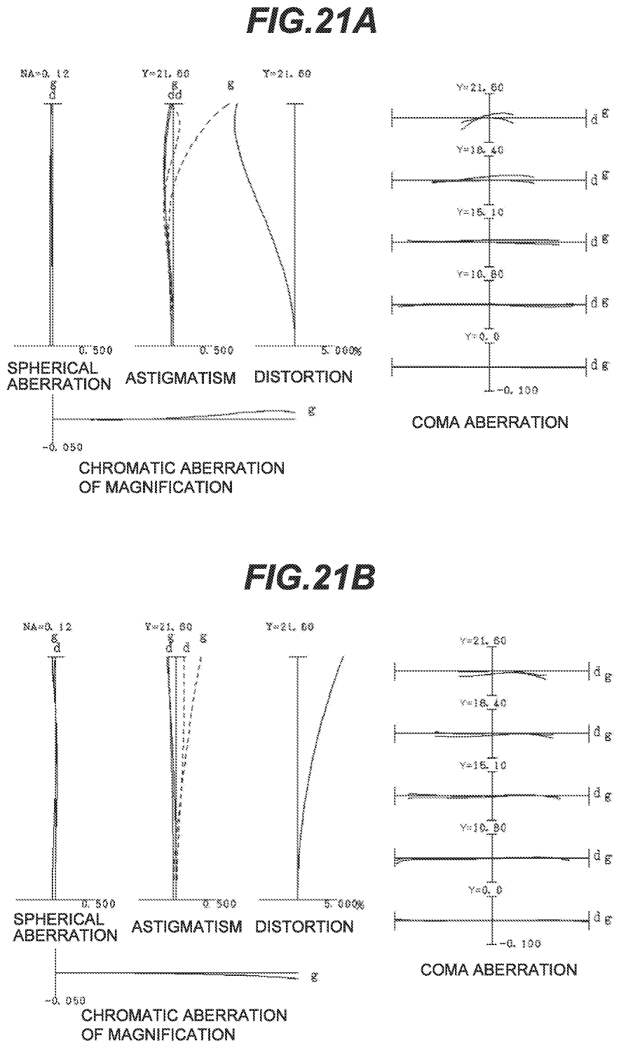

FIG. 20A illustrates various aberration diagrams of the zoom optical system according to the seventh example upon focusing on infinity in the wide-angle end state. FIG. 20B illustrates various aberration diagrams of the zoom optical system according to the seventh example upon focusing on infinity in the telephoto end state. FIG. 21A illustrates various aberration diagrams of the zoom optical system according to the seventh example upon focusing on a short-distance object in the wide-angle end state. FIG. 21B illustrates various aberration diagrams of the zoom optical system according to the seventh example upon focusing on a short-distance object in the telephoto end state. From the various aberration diagrams, it can be understood that the zoom optical system according to the seventh example has various aberrations excellently corrected in both the wide-angle end state and the telephoto end state not only upon focusing on infinity but also upon focusing on a short-distance object and has excellent imaging performance.

The following presents a table of [Conditional Expression Correspondence Value]. The table collectively lists values corresponding to the conditional expressions (1) to (21) for all examples (the first to seventh examples).

| | |
|---|---|
| Conditional Expression (1) | −0.37 < fFs/fFy < 0.37 |
| Conditional Expression (2) | 2.00 < f1/fw < 8.00 |
| Conditional Expression (3) | −6.00 < fFs/fw < 6.00 |
| Conditional Expression (4) | 4.30 < f1/(−fM1w) < 10.00 |
| Conditional Expression (5) | 1.50 < f1/fM21 < 7.00 |
| Conditional Expression (6) | 0.10 < BFw/fw < 1.00 |
| Conditional Expression (7) | 0.20 < \|fFs\|/f1 < 2.00 |
| Conditional Expression (8) | 1.50 < \|fFs\|/(−fM1w) < 5.00 |
| Conditional Expression (9) | 0.90 < \|fFs\|/fM2w < 4.00 |
| Conditional Expression (10) | 0.20 < f1/(−fRw) < 5.00 |
| Conditional Expression (11) | 0.10 < MTF1/MTF2 < 3.00 |
| Conditional Expression (12) | 0.10 < βF1w/βF2w < 3.00 |
| Conditional Expression (13) | 0.10 < βF1t/βF2t < 3.00 |
| Conditional Expression (14) | 0.50 < βF1w < 2.60 |
| Conditional Expression (15) | 0.20 < βF2w < 1.80 |
| Conditional Expression (16) | {βF1w + (1/βF1w)}⁻² ≤ 0.25 |
| Conditional Expression (17) | {βF2w + (1/βF2w)}⁻² ≤ 0.25 |
| Conditional Expression (18) | 0.10 < \|fFs\|/\|fRF\| < 4.00 |
| Conditional Expression (19) | 2ωw > 75.0° |
| Conditional Expression (20) | ft/fw > 3.50 |
| Conditional Expression (21) | 0.10 < (−fN)/fL < 1.00 |

[Conditional Expression Corresponding Value]
(First to Fourth Example)

| Conditional | First | Second | Third | Fourth |
|---|---|---|---|---|
| Expression | Example | Example | Example | Example |
| (1) | 0.119 | −0.034 | 0.217 | 0.037 |
| (2) | 3.932 | 4.500 | 6.953 | 4.181 |
| (3) | −1.547 | −1.279 | 3.722 | −1.457 |
| (4) | 5.502 | 6.518 | 7.481 | 5.766 |
| (5) | 2.424 | 3.217 | 2.639 | 2.298 |
| (6) | 0.555 | 0.464 | 0.507 | 0.504 |
| (7) | 0.393 | 0.284 | 0.535 | 0.349 |
| (8) | 2.165 | 1.852 | 4.005 | 2.010 |
| (9) | 1.281 | 1.087 | 2.511 | 1.208 |
| (10) | 2.094 | 1.822 | 0.991 | 2.321 |
| (11) | 0.407 | 0.284 | 1.442 | 0.432 |
| (12) | 0.679 | 0.626 | 0.807 | 0.644 |
| (13) | 0.359 | 0.263 | 0.695 | 0.282 |
| (14) | 1.071 | 1.045 | 0.770 | 1.005 |
| (15) | 1.577 | 1.670 | 0.954 | 1.561 |
| (16) | 0.249 | 0.250 | 0.234 | 0.250 |
| (17) | 0.205 | 0.194 | 0.249 | 0.206 |
| (18) | 0.296 | 0.402 | 1.922 | 0.211 |
| (19) | 85.22 | 85.22 | 91.54 | 85.20 |
| (20) | 4.737 | 4.737 | 4.558 | 7.854 |
| (21) | 0.296 | 0.402 | 0.303 | 0.211 |

[Conditional Expression Corresponding Value]
(Fifth to Seventh Example)

| Conditional | Fifth | Sixth | Seventh |
|---|---|---|---|
| Expression | Example | Example | Example |
| (1) | 0.037 | 0.109 | 0.241 |
| (2) | 4.123 | 5.440 | 6.806 |
| (3) | −1.479 | 1.758 | 3.742 |
| (4) | 5.889 | 6.750 | 7.554 |
| (5) | 2.254 | 2.534 | 5.560 |
| (6) | 0.504 | 0.500 | 0.521 |
| (7) | 0.359 | 0.323 | 0.550 |
| (8) | 2.112 | 2.182 | 4.154 |
| (9) | 1.246 | 1.333 | 2.537 |
| (10) | 2.280 | 0.707 | 0.868 |
| (11) | 0.391 | 1.073 | 1.403 |
| (12) | 0.647 | 0.806 | 0.805 |
| (13) | 0.283 | 0.725 | 0.692 |
| (14) | 1.002 | 0.765 | 0.763 |
| (15) | 1.550 | 0.949 | 0.948 |
| (16) | 0.250 | 0.233 | 0.233 |
| (17) | 0.208 | 0.249 | 0.249 |
| (18) | 0.203 | 0.917 | 1.880 |
| (19) | 85.20 | 86.44 | 91.56 |
| (20) | 7.854 | 4.696 | 4.558 |
| (21) | 0.203 | 0.213 | 0.300 |

According to the above-described examples, it is possible to achieve quiet and high-speed focusing without barrel size increase through size and weight reduction of focusing lens groups. Moreover, it is possible to achieve a zoom optical system with small aberration fluctuation upon zooming from the wide-angle end state to the telephoto end state and small aberration fluctuation upon focusing from an infinity object to a short-distance object.

The above-described examples are specific examples of the present application invention, and the present application invention is not limited thereto.

Contents of the following description may be applied as appropriate without losing the optical performance of a zoom optical system of the present embodiment.

Each above-described example of the zoom optical system of the present embodiment has a seven-group configuration or an eight-group configuration, but the present application is not limited thereto and the zoom optical system may have any other group configuration (for example, a nine-group configuration). Specifically, a lens or a lens group may be added closest to the object side or the image surface side in the zoom optical system of the present embodiment. Note that a lens group means a part comprising at least one lens and separated at an air distance that changes upon zooming.

The focusing lens groups may perform focusing from an infinity object to a short-distance object by moving one or a plurality of lens groups or a partial lens group in the optical axis direction. The focusing lens groups are also applicable to automatic focusing and also suitable for automatic focusing motor drive (using an ultrasonic wave motor or the like).

A lens group or a partial lens group may be moved with a component in a direction orthogonal to the optical axis or may be rotationally moved (swung) in an in-plane direction including the optical axis, thereby achieving a vibration-proof lens group that corrects image blur caused by camera shake.

A lens surface may be a spherical surface, a flat surface, or an aspherical surface. The lens surface is preferably a spherical surface or a flat surface because it is easy to perform lens fabrication and assembly adjustment, and it is possible to prevent optical performance degradation due to error in fabrication and assembly adjustment. Moreover, a spherical surface or a flat surface is preferable because graphic performance degradation is small when the image surface is shifted.

When the lens surface is an aspherical surface, the aspherical surface may be an aspherical surface formed by grinding fabrication, a glass mold aspherical surface formed by shaping glass in an aspherical shape with a mold, or a composite type aspherical surface formed by shaping resin in an aspherical shape on the surface of glass. Moreover, the lens surface may be a diffraction surface, and the lens may be a graded-index lens (GRIN lens) or a plastic lens.

The aperture stop is preferably disposed between the second lens group and the third lens group or between the third lens group and the fourth lens group, but no member may be provided as the aperture stop and the frame of a lens may provide functions thereof.

An antireflection film having a high transmittance in a wide wavelength band may be provided on each lens surface to reduce flare and ghost, thereby achieving high-contrast optical performance.

### EXPLANATION OF NUMERALS AND CHARACTERS

G1 first lens group G2 second lens group
G3 third lens group G4 fourth lens group
G5 fifth lens group G6 sixth lens group
G7 seventh lens group G8 eighth lens group
I image surface S aperture stop

1. A zoom optical system comprising a front-side lens group having positive refractive power, a first middle lens group having negative refractive power, a second middle lens group having positive refractive power, and a succeeding lens group, the lens groups being arranged in order from an object side along an optical axis, wherein
intervals of the lens groups adjacent to each other change at zooming,
the succeeding lens group includes a first focusing lens group disposed closest to the object side in the succeeding lens group and configured to move along the optical axis upon focusing, and at least one other focusing lens group disposed on an image side of the first focusing lens group and configured to move along the optical axis with a locus different from a locus of the first focusing lens group upon focusing, and
the following conditional expressions are satisfied:
−0.37<fFs/fFy<0.37
2.00<f1/fw<8.00
where
fFs: focal length of a focusing lens group having strongest refractive power among the focusing lens groups included in the succeeding lens group,
fFy: focal length of a focusing lens group having weakest refractive power among the focusing lens groups included in the succeeding lens group,
f1: focal length of the front-side lens group, and
fw: focal length of the zoom optical system in a wide-angle end state.

2. The zoom optical system according to claim 1, wherein the following conditional expression is satisfied:
−6.00<fFs/fw<6.00 (3)

3. The zoom optical system according to claim 1, wherein the following conditional expression is satisfied:
4.30<f1/(−fM1w)<10.00 (4)
where
fM1w: focal length of the first middle lens group in the wide-angle end state.

4. The zoom optical system according to claim 1, wherein
the second middle lens group includes at least two lens groups having positive refractive power, and
the following conditional expression is satisfied:
1.50<f1/fM21<7.00
where
fM21: focal length of a lens group closest to the object side among lens groups included in the second middle lens group.

5. The zoom optical system according to claim 1, wherein the following conditional expression is satisfied:
0.10<BFw/fw<1.00
where
BFw: back focus of the zoom optical system in the wide-angle end state.

6. The zoom optical system according to claim 1, wherein the following conditional expression is satisfied:
0.20<|fFs|/f1<2.00.

7. The zoom optical system according to claim 1, wherein the following conditional expression is satisfied:
1.50<|fFs|/(−fM1w)<5.00
where
fM1w: focal length of the first middle lens group in the wide-angle end state.

8. The zoom optical system according to claim 1, wherein the following conditional expression is satisfied:
0.90<|fFs|/fM2w<4.00
where
fM2w: focal length of the second middle lens group in the wide-angle end state.

9. The zoom optical system according to claim 1, wherein the following conditional expression is satisfied:
0.20<f1/(−fRw)<5.00
where
fRw: focal length of the succeeding lens group in the wide-angle end state.

10. The zoom optical system according to claim 1, wherein the following conditional expression is satisfied:
0.10<MTF1/MTF2<3.00
where
MTF1: absolute value of a moving amount of the first focusing lens group upon focusing from an infinity object to a short-distance object in a telephoto end state, and
MTF2: absolute value of a moving amount of a focusing lens group closest to the first focusing lens group among the other focusing lens groups upon focusing from an infinity object to a short-distance object in the telephoto end state.

11. The zoom optical system according to claim 1, wherein the following conditional expression is satisfied:
0.10<βF1w/βF2w<3.00
where
βF1w: combined lateral magnification of focusing lens groups positioned on the object side of a focusing lens group closest to the image side among the focusing lens groups included in the succeeding lens group upon focusing on an infinity object in the wide-angle end state, and
βF2w: lateral magnification of the focusing lens group closest to the image side among the focusing lens groups included in the succeeding lens group upon focusing on an infinity object in the wide-angle end state.

12. The zoom optical system according to claim 1, wherein the following conditional expression is satisfied:
0.10<βF1t/βF2t<3.00
where
βF1t: combined lateral magnification of focusing lens groups positioned on the object side of a focusing lens group closest to the image side among the focusing lens groups included in the succeeding lens group upon focusing on an infinity object in a telephoto end state, and
βF2t: lateral magnification of the focusing lens group closest to the image side among the focusing lens groups included in the succeeding lens group upon focusing on an infinity object in the telephoto end state.

13. The zoom optical system according to claim 1, wherein the following conditional expression is satisfied:
0.50<βF1w<2.60
where
βF1w: combined lateral magnification of focusing lens groups positioned on the object side of a focusing lens group closest to the image side among the focusing lens groups included in the succeeding lens group upon focusing on an infinity object in the wide-angle end state.

14. The zoom optical system according to claim 1, wherein the following conditional expression is satisfied:
0.20<βF2w<1.80
where
βF2w: lateral magnification of a focusing lens group closest to the image side among the focusing lens groups included in the succeeding lens group upon focusing on an infinity object in the wide-angle end state.

15. The zoom optical system according to claim 1, wherein the following conditional expression is satisfied:
{<F1w+(1/(βF1w)}⁻²≤0.25
where
βF1w: combined lateral magnification of focusing lens groups positioned on the object side of a focusing lens group closest to the image side among the focusing lens groups included in the succeeding lens group upon focusing on an infinity object in the wide-angle end state.

16. The zoom optical system according to claim 1, wherein the following conditional expression is satisfied:
{βF2w+(1/βF2w)}⁻²≤0.25
where
βF2w: lateral magnification of the focusing lens group closest to the image side among the focusing lens groups included in the succeeding lens group upon focusing on an infinity object in the wide-angle end state.

17. The zoom optical system according to claim 1, wherein the succeeding lens group includes at least one lens group disposed on the image side of a focusing lens group closest to the image side among the focusing lens groups included in the succeeding lens group.

18. The zoom optical system according to claim 17, wherein the following conditional expression is satisfied:
0.10<|fFs|/|fRF|<4.00
where
fRF: focal length of a lens group disposed side by side on the image side of a focusing lens group closest to the image side in the at least one lens group.

19. The zoom optical system according to claim 1, wherein the following conditional expression is satisfied:
2ωw>75.0°
where 2ωw: full angle of view of the zoom optical system in the wide-angle end state.

20. The zoom optical system according to claim 1, wherein the following conditional expression is satisfied:
ft/fw>3.50
where
ft: focal length of the zoom optical system in a telephoto end state.

21. The zoom optical system according to claim 1, wherein the following conditional expression is satisfied:
0.10<(−fN)/fL<1.00
where
fN: focal length of a lens disposed second closest to the image side in the zoom optical system, and
fL: focal length of a lens disposed closest to the image side in the zoom optical system.

22. An optical apparatus comprising the zoom optical system according to claim 1.

23. A method for manufacturing a zoom optical system comprising a front-side lens group having positive refractive power, a first middle lens group having negative refractive power, a second middle lens group having positive refractive power, and a succeeding lens group, the lens groups being arranged in order from an object side along an optical axis,
the method comprising a step of disposing the front-side lens group, the first middle lens group, the second middle lens group and the succeeding lens group in a lens barrel so that:
intervals of the lens groups adjacent to each other change at zooming,
the succeeding lens group includes a first focusing lens group disposed closest to the object side in the succeeding lens group and configured to move along the optical axis upon focusing, and at least one other focusing lens group disposed on an image side of the first focusing lens group and configured to move along the optical axis with a locus different from a locus of the first focusing lens group upon focusing, and
the following conditional expressions are satisfied:
−0.37<fFs/fFy<0.37
2.00<f1/fw<8.00
where
fFs: focal length of a focusing lens group having strongest refractive power among the focusing lens groups included in the succeeding lens group,
fFy: focal length of a focusing lens group having weakest refractive power among the focusing lens groups included in the succeeding lens group,
f1: focal length of the front-side lens group, and
fw: focal length of the zoom optical system in a wide-angle end state.
